(19) United States
(12) Patent Application Publication
(10) Pub. No.: US 2026/0099817 A1
(43) Pub. Date: Apr. 9, 2026

(54) IMMUTABLE LEDGER ENABLED AUTOMATIC PROCUREMENT SYSTEM

(71) Applicant: Clemson University, Clemson, SC (US)

(72) Inventors: Sean McNamara, Clemson, SC (US); Istiqlal Aurangzeb, Clemson, SC (US); Jong Han Yoon, Clemson, SC (US)

(73) Assignee: Clemson University, Clemson, SC (US)

(21) Appl. No.: 19/352,609

(22) Filed: Oct. 8, 2025

Related U.S. Application Data
(60) Provisional application No. 63/704,560, filed on Oct. 8, 2024.

(51) Int. Cl. G06Q 10/10; G06F 7/08; G06Q 10/109; G06Q 50/08

(52) U.S. Cl. CPC G06Q 10/103; G06F 7/08; G06Q 10/109; G06Q 50/08

(57) ABSTRACT

The present disclosure provides a computerized automated procurement system comprising a server in communications with an immutable ledger, a first computer system in communications with the server adapted for receiving project requirements from a contractor, wherein the project requirements include work schedules, project locations, work types, material specifications, labor requirements, and cost estimates, a second computer system in communications with the server for receiving subcontractor data representing subcontractors, wherein the server matches the contractor with subcontractors according to the project requirements and subcontractor data, and creates a proposed smart contract for each contractor and subcontractor match. The system eliminates relationship bias through blockchain-enabled smart contracts that maintain subcontractor anonymity during evaluation and provide objective matching based on trust scores calculated from historical performance metrics.

### CROSS-REFERENCE TO RELATED APPLICATIONS

This application claims priority to U.S. Provisional Patent Application No. 63/704,560 filed Oct. 8, 2024 which is hereby incorporated by reference in its entirety.

### BACKGROUND

### 1) Field of the Invention

The present disclosure relates to automated procurement systems for construction projects, and more particularly to a blockchain-enabled procurement system that integrates Building Information Modeling (BIM) and smart contracts to facilitate automatic matching of general contractors with subcontractors while eliminating relationship bias in the procurement process.

### 2) Description of Related Art

In the construction industry, general contractors are responsible for overseeing construction projects and typically hire subcontractors to perform specialized tasks within their areas of expertise. The procurement process for selecting subcontractors involves multiple stages, including determining project scope, evaluating potential subcontractors based on various parameters such as price and quality, and finalizing contract agreements.

Traditional subcontractor procurement processes often rely on established relationships between general contractors and subcontractors from previous projects. While relationship-based procurement can facilitate contract processes and enable early involvement of subcontractors in pre-contract phases, this approach can create barriers for qualified subcontractors who lack prior relationships with general contractors. Such barriers can limit the pool of available subcontractors and may hinder competitive bidding processes.

The construction procurement process typically involves extensive documentation, data management, and evaluation of multiple criteria including cost, schedule, quality, and performance history. Managing this information across multiple stakeholders can be complex and time-consuming, particularly when dealing with large-scale construction projects that involve numerous subcontractors and suppliers.

Building Information Modeling (BIM) has emerged as a workflow system that compiles and shares construction data and 3D model objects for collaboration purposes throughout building lifecycles. BIM enables project stakeholders to create model components that include information relevant to each project phase, which can be integrated to generate insights for data-driven decision making. However, extracting and utilizing BIM data for procurement processes can present technical challenges, particularly when transforming data into formats suitable for procurement evaluation.

Blockchain technology offers decentralized, secure, and transparent digital transaction capabilities through cryptographic mechanisms that ensure data integrity and continuity. Smart contracts, which are self-executing digital contracts with terms written directly into programming code, can automate various business processes while eliminating the need for intermediaries. These technologies have shown potential for digitizing and automating processes in various industries, including healthcare, manufacturing, insurance, and real estate. It would be advantageous to deploy this technology in the construction industry.

The integration of digital technologies in construction procurement processes presents opportunities for improving efficiency, transparency, and fairness in subcontractor selection. However, existing systems may not fully leverage the combined benefits of BIM-based project management, blockchain technology, and smart contracts to create comprehensive automated procurement solutions that address relationship bias and expand subcontractor participation opportunities.

Smart contracts may provide significant benefits to the construction industry by automating contract execution and reducing reliance on intermediaries throughout the procurement process. In some aspects, smart contracts can automatically trigger payments upon completion of predefined milestones, reducing payment delays and disputes that commonly occur in construction projects. The technology may also enhance transparency by providing all stakeholders with real-time access to contract terms and execution status, which can improve trust and collaboration among project participants. In some cases, smart contracts can reduce administrative overhead by automatically enforcing contract terms and conditions without requiring manual intervention from project managers or legal teams. Additionally, the immutable nature of blockchain-based smart contracts may help prevent contract disputes by maintaining a permanent, tamper-proof record of all contract modifications and executions, thereby reducing the time and costs associated with legal proceedings in construction projects.

Despite the potential benefits of blockchain technology and smart contracts, the construction industry has been slow to adopt these digital solutions due to several barriers that prevent effective implementation. Traditional construction procurement processes remain heavily reliant on manual documentation, paper-based contracts, and relationship-driven decision making, which may limit transparency and create inefficiencies in subcontractor selection. Many construction companies may lack the technical infrastructure and expertise required to implement blockchain-based systems, while concerns about data security, regulatory compliance, and integration with existing project management systems can create additional adoption challenges. In some cases, the fragmented nature of the construction industry, with numerous small and medium-sized contractors and subcontractors, may hinder the widespread adoption of standardized digital procurement platforms. Furthermore, existing procurement systems may not provide automated matching capabilities that eliminate relationship bias, comprehensive trust factor calculations based on historical performance data, or seamless integration with BIM data for project-specific subcontractor evaluation. Without these technological capabilities, the construction industry may continue to experience inefficiencies in procurement processes, limited access to qualified subcontractors, and reduced transparency in contractor selection decisions.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a computerized automated procurement system is provided. The system comprises a server in communications with an immutable ledger. The system comprises a first computer system in communications with the server adapted for receiving a set of project requirements originating from a contractor, wherein the set of project requirements includes project information comprising work schedules, project locations, work types, material specifications, labor requirements, and cost estimates. The system comprises a second computer system in communications with the server for receiving subcontractor data representing a set of subcontractors. The server is adapted to match the contractor with a subset of subcontractors taken from the set of subcontractors according to the set of project requirements and subcontractor data. The system creates a proposed smart contract for each contractor and subcontractor match.

According to other aspects of the present disclosure, the system may include one or more of the following features. The server may include artificial intelligence algorithms configured to analyze the subcontractor data and project requirements to optimize the matching process and enhance selection accuracy. The subcontractor data may include data selected from the group consisting of available dates, available locations, work type capabilities, material type specifications, material pricing, labor pricing, equipment pricing, and performance history. The server may be configured to create a trust score associated with each subcontractor in the set of subcontractors based on historical performance metrics. The trust score may be calculated according to criteria selected from the group consisting of cost conformity, time conformity, quality conformity, and any combination thereof. The server may be adapted to present the subset of subcontractors in trust score order from highest to lowest trust score. The first computer system may be adapted to receive Building Information Modeling (BIM) data and extract the set of project requirements from the BIM data using computer readable instructions configured to parse CSV files generated by BIM software.

According to another aspect of the present disclosure, a computer system adapted for blockchain-enabled procurement is provided. The system comprises a blockchain storage system configured to store contractor project requirements and subcontractor specification data. The system comprises a matching module configured to evaluate compatibility between project requirements and subcontractor capabilities using location matching, schedule overlap analysis, and work type capability assessment. The system comprises a trust factor calculation module configured to calculate trust scores for subcontractors based on historical performance data including cost conformity, time adherence, and quality delivery metrics. The system comprises a smart contract execution module configured to automate procurement processes and generate anonymized shortlists of qualified subcontractors ranked according to trust factor values.

According to other aspects of the present disclosure, the computer system may include one or more of the following features. The blockchain storage system may store contractor data, subcontractor data, project data, and smart contract data on an immutable ledger to ensure permanent and tamper-proof storage of procurement information. The matching module may implement keccak256 hash functions for location matching and temporal comparison algorithms for schedule overlap analysis that verify subcontractor availability periods encompass required project execution timeframes. The system may include an artificial intelligence assisted subcontractor selection process that learns from past selection outcomes to improve future matching accuracy, wherein the artificial intelligence algorithms analyze historical selection patterns, project success rates, and performance correlations to refine matching criteria and enhance automated decision-making capabilities over time. The trust factor calculation module may implement averaging algorithms that combine new performance ratings with existing historical ratings to introduce gradual adjustments to trust factor values while preventing dramatic fluctuations based on single project outcomes. The smart contract execution module may maintain subcontractor anonymity during evaluation processes by using index-based identification systems instead of direct subcontractor identifiers to eliminate relationship bias in selection decisions.

According to another aspect of the present disclosure, a computerized system for eliminating relationship bias in construction procurement is provided. The system comprises a distributed blockchain network configured to store encrypted procurement data with selective access controls. The system comprises a Building Information Modeling data integration module configured to extract and process construction project data from BIM software applications. The system comprises a crypto wallet interface module configured to provide secure blockchain connectivity for contractors and subcontractors. The system comprises an automated matching algorithm configured to systematically evaluate subcontractor compatibility using cryptographic hash functions for location matching and temporal comparison algorithms for schedule overlap analysis. The system maintains subcontractor anonymity during evaluation processes by using index-based identification systems that prevent selection decisions based on prior relationships. The system provides subcontractors in ranking order to the contractor based on trust factor values and compatibility metrics. When the contractor selects a subcontractor from the ranked list, the relationship is memorialized by smart contract execution that records the selection decision immutably on the blockchain network.

According to other aspects of the present disclosure, the computerized system may include one or more of the following features. The distributed blockchain network may utilize Ethereum blockchain technology with smart contracts to ensure immutable storage and cryptographic security of procurement data. The Building Information Modeling data integration module may implement Papa Parse functionality to extract work types, material specifications, quantity measurements, and cost estimates from generated by BIM software applications. The system functionality may convert BIM-generated CSV files to JSON objects through systematic parsing operations that remove header information and add unique key identifiers to each parsed data item. The crypto wallet interface module may utilize MetaMask accounts to provide private keys and enable connection to decentralized applications through web browsers or mobile app built-in browsers. The automated matching algorithm may implement quicksort functionality to arrange qualified subcontractors in descending order based on trust factor values derived from historical performance evaluations including cost conformity, time adherence, and quality delivery metrics. The quicksort functionality may utilize pivot selection using a formula that calculates left plus the result of right minus left divided by two, where left and right represent array boundaries for current sorting operations.

The foregoing general description of the illustrative embodiments and the following detailed description thereof are merely exemplary aspects of the teachings of this disclosure and are not restrictive.

### BRIEF DESCRIPTION OF FIGURES

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 illustrates a system diagram showing data flow between a general contractor and subcontractors, according to aspects of the present disclosure.

FIG. 2 shows a detailed system architecture diagram with contractor and subcontractor user accounts, according to an embodiment.

FIG. 3 illustrates a flowchart of a trust factor determination process, according to aspects of the present disclosure.

FIG. 4 illustrates a flowchart for finding matching subcontractors, according to an embodiment.

FIG. 5A illustrates a flowchart for selecting matching subcontractors and calculating project information, according to aspects of the present disclosure.

FIGS. 5B-5D illustrate flowcharts for sorting subcontractors by trust factor and calculating costs, according to an embodiment.

FIG. 6A illustrates a flowchart for contractor and subcontractor access control and matching processes, according to aspects of the present disclosure.

FIG. 6B illustrates a flowchart for finalizing winner selection and trust factor determination, according to an embodiment.

FIG. 7 shows a diagram illustrating BIM model data with a building structure, according to aspects of the present disclosure.

FIG. 8 depicts a user interface screen for a contractor interface, according to an embodiment.

FIG. 9 illustrates data input interfaces showing contractor and subcontractor data input, according to aspects of the present disclosure.

FIGS. 10-11 illustrate a sequence diagram showing interactions between system components for subcontractor selection, according to an embodiment.

FIG. 12 illustrates a sequence diagram showing smart contract blocks and transaction costs, according to aspects of the present disclosure.

FIG. 13 depicts a heat map showing execution costs for different transaction speeds, according to an embodiment.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order.

With reference to the drawings, the invention will now be described in more detail.

The present disclosure relates to a blockchain-enabled automatic procurement system that transforms traditional construction procurement processes through the integration of Building Information Modeling (BIM), intelligent input and smart contract technology. The system may address challenges in conventional procurement where general contractors typically select subcontractors from limited pools based on past relationships, which may create barriers for qualified subcontractors lacking prior relationships and may result in relationship bias that impedes fair competition.

The system may utilize blockchain technology to create an immutable ledger for storing procurement-related data, ensuring transparency and traceability throughout the procurement process. Smart contracts may automate the matching process between general contractors and subcontractors based on objective criteria rather than subjective relationship factors. The system may integrate BIM-based project management to extract and process construction project data in a structured format that facilitates automated decision-making.

General contractors may input project requirements data including work schedules, locations, work types, material specifications, and cost estimates into the system. Subcontractors may provide specification data including availability schedules, service locations, work capabilities, and pricing information. The system may process this information through automated algorithms that match contractors with suitable subcontractors based on compatibility of project requirements and subcontractor capabilities.

The system may eliminate relationship bias by maintaining anonymity of participants during the matching process, allowing evaluation based solely on objective performance metrics and project compatibility. Trust scores may be calculated for subcontractors based on past performance in areas such as cost conformity, time adherence, and quality delivery. These trust scores may be derived from performance evaluations provided by previous project stakeholders and may be stored immutably on the blockchain ledger.

The decentralized nature of the blockchain-enabled system may ensure that no single entity controls the procurement data or decision-making process. Smart contracts may execute automatically when predetermined conditions are met, reducing the need for manual intervention and potential human bias in the selection process. The system may expand the pool of available subcontractors by providing equal access to procurement opportunities regardless of existing relationships with general contractors.

The automated matching process may evaluate multiple parameters simultaneously, including geographic location compatibility, schedule alignment, technical capabilities, pricing competitiveness, and historical performance metrics. The system may generate shortlists of qualified subcontractors ranked according to objective criteria, enabling general contractors to make informed decisions based on comprehensive data analysis rather than relationship preferences.

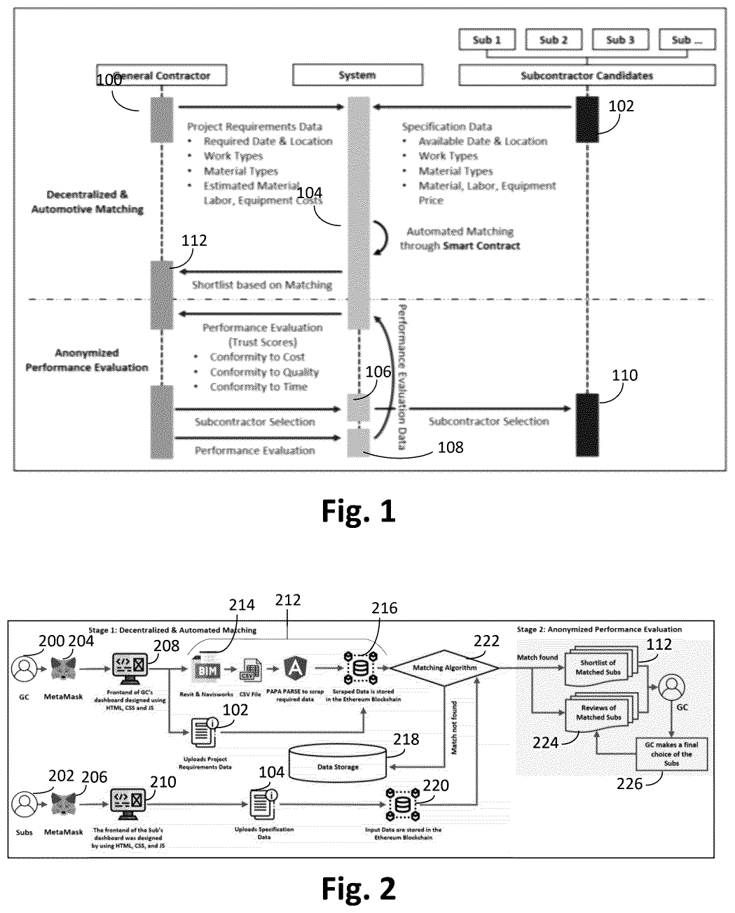

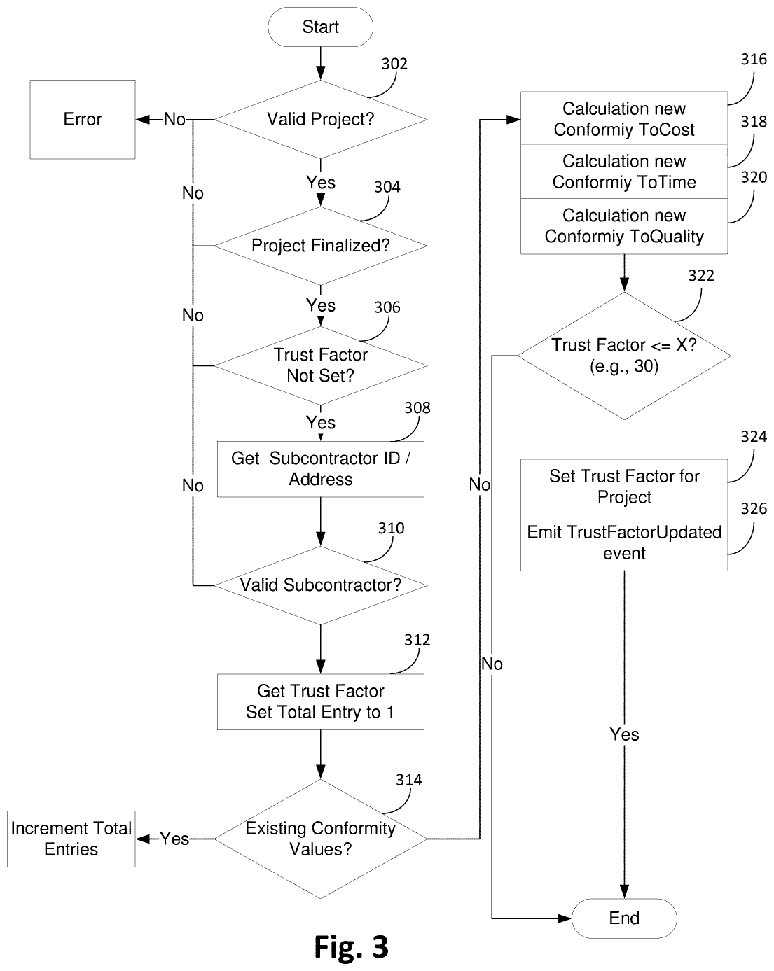

Referring to FIGS. 1-2, the system architecture may facilitate data flow between general contractors and subcontractors through a comprehensive blockchain-enabled platform. As shown in FIG. 1, general contractor project requirement data 100 may include work schedules, project locations, work types, material specifications, labor requirements, and cost estimates that define the parameters for construction projects. Subcontractor specification data 102 may encompass availability schedules, service locations, work capabilities, material costs, labor costs, and equipment pricing information provided by potential subcontractors.

The general contractor project requirement data 100 and subcontractor specification data 102 may be processed through contractor and subcontractor matching 104, which may evaluate compatibility between project requirements and subcontractor capabilities. The contractor and subcontractor matching 104 may lead to subcontractor selection 106 based on objective criteria analysis. Performance evaluation 108 may assess subcontractor qualifications using historical performance metrics, cost conformity, time adherence, and quality delivery measures. The performance evaluation 108 may inform current subcontractor selection 110 processes and may generate short list matching 112 that ranks qualified subcontractors according to predetermined evaluation parameters.

With continued reference to FIGS. 1-2, the system may implement the blockchain technology, including Ethereum, as the immutable ledger implementation with smart contracts written in Solidity programming language. As illustrated in FIG. 2, a contractor user account 200 may provide access for general contractors to input project data and review subcontractor proposals. A subcontractor user account 202 may enable subcontractors to submit specification data and respond to project opportunities. The contractor user account 200 may interface with a contractor crypto wallet interface 204, while the subcontractor user account 202 may connect to a subcontractor crypto wallet interface 206.

The contractor crypto wallet interface 204 and subcontractor crypto wallet interface 206 may use MetaMask accounts to provide private keys and enable connection to decentralized applications through web browsers or mobile app built-in browsers. The contractor crypto wallet interface 204 may facilitate secure blockchain transactions for general contractors, while the subcontractor crypto wallet interface 206 may enable subcontractors to participate in the blockchain-based procurement process. These interfaces may ensure cryptographic security and user authentication for all blockchain interactions.

As further shown in FIG. 2, a contractor dashboard 208 may provide a user interface for general contractors to manage project data, review subcontractor matches, and make selection decisions. A subcontractor dashboard 210 may offer subcontractors access to available project opportunities, submission of specification data, and tracking of proposal status. The contractor dashboard 208 and subcontractor dashboard 210 may present information in structured formats that facilitate efficient decision-making and data management.

Contractor uploads 212 may enable general contractors to submit project information to the system, including BIM data 214 that contains structured construction project information. The BIM data 214 may include three-dimensional model components, material specifications, quantity takeoffs, cost estimates, and scheduling information extracted from Building Information Modeling software. Contractor uploads storage 216 may receive and temporarily store uploaded project data before processing and integration into the blockchain system.

The system may include a project database 218 that organizes and manages project-related information, and blockchain storage 220 that provides immutable storage for procurement data using distributed ledger technology. The blockchain storage 220 may store encrypted project data in the blockchain network that may be shared only with matched subcontractors, and subcontractor specification data that may be shared only with general contractors when there is a match. This selective data sharing approach may prevent unnecessary disclosure of sensitive pricing and specification information.

System computer readable instructions 222 may process the uploaded data and execute automated matching algorithms that evaluate compatibility between general contractor requirements and subcontractor capabilities. The system computer readable instructions 222 may implement smart contract logic written in Solidity programming language that automates the procurement process without manual intervention. These instructions may facilitate contractor review of subcontractors 224 by generating ranked lists of qualified candidates based on objective evaluation criteria. The contractor review of subcontractors 224 may lead to subcontractor selection 226 where general contractors may choose from the presented shortlist of qualified subcontractors based on comprehensive performance and compatibility analysis.

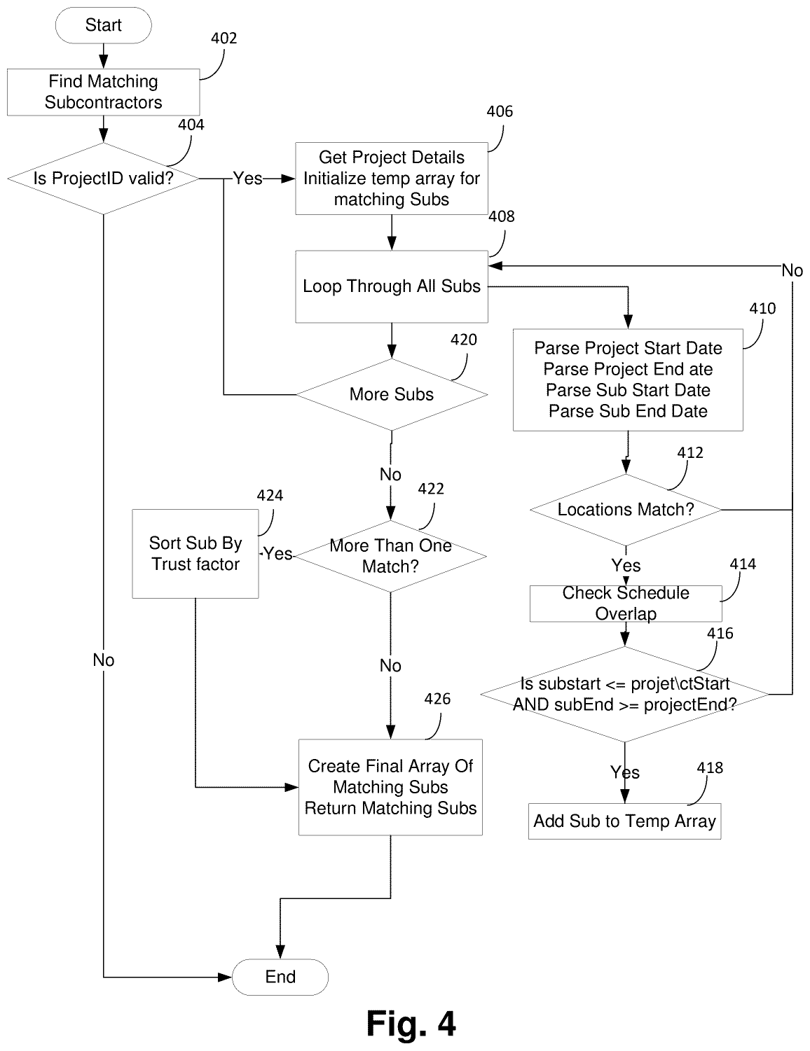

Referring to FIG. 3, the system may implement a trust factor determination process that validates project identification and verifies project finalization status to ensure accurate performance evaluation of subcontractors. The trust factor determination process may begin with a valid project 302 verification step that confirms the project identification corresponds to an existing project within the system. The valid project 302 verification may prevent processing of invalid or non-existent project data that could compromise the accuracy of trust factor calculations.

The process may proceed to a project finalize 304 verification that determines whether the project has reached completion status. The project finalize 304 verification may ensure that trust factor evaluations are conducted only for completed projects where subcontractor performance can be comprehensively assessed. Projects that have not reached finalization status may return to the valid project 302 verification step to await completion before trust factor processing can proceed.

Following successful project validation, the system may check for a trust factor set 306 status that determines whether trust factors have already been established for the specific project. The trust factor set 306 verification may prevent duplicate trust factor calculations and may ensure that each completed project receives a single comprehensive performance evaluation. When trust factors have not been previously established, the process may advance to subcontractor information retrieval.

The system may execute get subcontractor information 308 operations that retrieve comprehensive data about the subcontractor associated with the completed project. The get subcontractor information 308 process may access stored subcontractor records from the blockchain storage 220 and may compile performance-related data for evaluation. Following information retrieval, the system may perform a valid subcontractor 310 verification that confirms the subcontractor data corresponds to a registered participant in the system.

With continued reference to FIG. 3, the valid subcontractor 310 verification may ensure that trust factor calculations are performed only for legitimate subcontractors with verified registration status. The system may then execute get trust factor set entry 312 operations that retrieve existing trust factor data for the subcontractor from previous projects. The get trust factor set entry 312 process may access historical performance metrics stored in the blockchain storage 220 to establish baseline values for trust factor calculations.

The process may evaluate conformity value 314 parameters that assess subcontractor performance across multiple evaluation criteria. The conformity value 314 assessment may include specific parameters such as nonconformity to design decisions, time lags and delays, inappropriate materials or equipment usage, work omitted or partially performed, failure to comply with quality specifications, and failure to complete contracts due to financial problems. These parameters may be categorized into three primary factors for systematic evaluation.

The system may perform calculate conformity to cost 316 operations that evaluate the subcontractor's adherence to agreed-upon cost parameters during project execution. The calculate conformity to cost 316 process may assess cost overruns, budget compliance, and financial performance relative to contracted amounts. Similarly, the system may execute calculate conformity to time 318 operations that measure the subcontractor's adherence to project schedules and delivery timelines. The calculate conformity to time 318 evaluation may consider delays, schedule compliance, and temporal performance metrics.

As further shown in FIG. 3, the system may conduct calculate conformity to quantity 320 operations that assess the subcontractor's delivery of work quality relative to specified standards and requirements. The calculate conformity to quantity 320 evaluation may measure workmanship quality, specification compliance, and adherence to construction standards. Each of these conformity calculations may generate numerical ratings that reflect subcontractor performance in the respective evaluation categories.

The conformity calculations may implement averaging algorithms that combine new performance ratings with existing historical ratings to introduce gradual adjustments to trust factor values. This averaging approach may prevent dramatic fluctuations in trust scores based on single project outcomes and may provide more stable and representative performance assessments over time. The averaging process may weight recent performance data appropriately while maintaining consideration of historical performance patterns.

Following the completion of conformity calculations, the system may execute determine trust factor value 322 operations that combine the individual conformity ratings into a comprehensive trust score. The determine trust factor value 322 process may sum the conformity to cost, conformity to time, and conformity to quality ratings to generate an overall trust factor value. The system may validate that the calculated trust factor value falls within acceptable parameters, such as a maximum threshold of thirty points, to ensure scoring consistency.

The system may then perform set project trust factor 324 operations that store the calculated trust factor value in association with the specific project and subcontractor. The set project trust factor 324 process may record the trust factor data in the blockchain storage 220 to ensure immutable storage and traceability of performance evaluations. Finally, the system may execute emit trust factor update 326 operations that generate blockchain events notifying relevant system participants of the completed trust factor calculation.

The trust factor determination process may reduce risks in subcontractor selection by providing objective performance metrics based on historical project outcomes. The systematic evaluation of cost conformity, time adherence, and quality delivery may enable general contractors to make informed selection decisions that reduce the likelihood of project delays, cost overruns, and quality issues. The immutable storage of trust factor data in the blockchain storage 220 may ensure that performance evaluations cannot be altered or manipulated, providing reliable assessment data for future procurement decisions. This comprehensive risk reduction approach may improve overall project outcomes by facilitating the selection of subcontractors with demonstrated performance capabilities across multiple evaluation criteria.

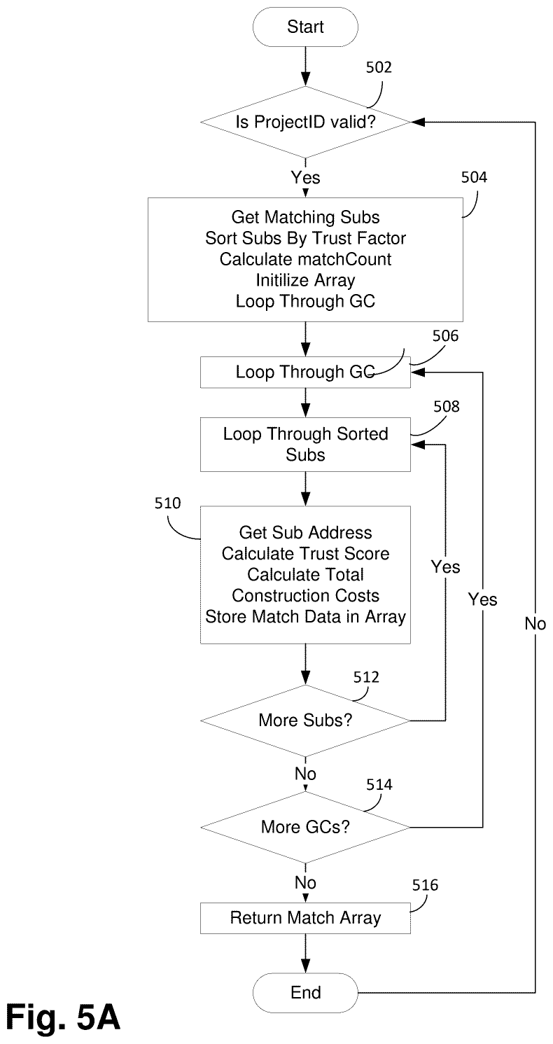

Referring to FIG. 4, the system may implement an automated subcontractor matching process that systematically evaluates compatibility between project requirements and subcontractor capabilities through a comprehensive algorithmic approach. The automated matching process may begin with find matching subcontractors 402 operations that initiate the evaluation sequence for identifying suitable subcontractors for specific construction projects. The find matching subcontractors 402 process may access the project database 218 and blockchain storage 220 to retrieve relevant project and subcontractor information for compatibility analysis.

The system may perform a valid project identification 404 verification that confirms the project identification corresponds to an existing project within the system database. The valid project identification 404 verification may prevent processing of invalid or non-existent project data that could compromise the accuracy of matching algorithms. When the project identification fails validation, the matching process may terminate to prevent erroneous matching operations. When the project identification passes validation, the system may proceed to data retrieval operations.

Following successful project validation, the system may execute retrieve project and subcontractor details 406 operations that compile comprehensive information from the project database 218 and blockchain storage 220. The retrieve project and subcontractor details 406 process may initialize a temporary array structure for storing potential matching subcontractors during the evaluation process. The temporary array may provide dynamic storage capacity that accommodates varying numbers of qualified subcontractors for different projects.

With continued reference to FIG. 4, the system may implement search subcontractors 408 operations that systematically iterate through all registered subcontractors in the system database. The search subcontractors 408 process may access subcontractor specification data 102 for each registered participant to evaluate compatibility with the general contractor project requirement data 100. The iterative search process may ensure comprehensive evaluation of all available subcontractors without bias toward specific participants or relationship preferences.

For each subcontractor evaluation, the system may perform parse project and subcontractor information 410 operations that extract and process temporal data from both project requirements and subcontractor availability schedules. The parse project and subcontractor information 410 process may extract project start dates, project end dates, subcontractor start dates, and subcontractor end dates from the stored data structures. The parsing operations may convert date information into standardized formats that facilitate accurate temporal compatibility analysis.

The system may execute determine location match 412 operations that evaluate geographic compatibility between project locations and subcontractor service areas. The determine location match 412 process may utilize a keccak256 hash function to compare subcontractor location data with project location requirements for precise matching purposes. The keccak256 hash function may provide cryptographic comparison capabilities that ensure accurate location matching while maintaining data security and integrity within the blockchain-enabled system.

As further shown in FIG. 4, the system may conduct check schedule 414 operations that assess temporal compatibility between project timelines and subcontractor availability periods. The check schedule 414 process may implement schedule overlap algorithms that determine whether subcontractor availability periods encompass the required project execution timeframes. The schedule overlap evaluation may verify that subcontractor start dates occur before or coincide with project start dates and that subcontractor end dates occur after or coincide with project completion dates.

The system may perform filter subcontractor 416 operations that evaluate whether individual subcontractors meet the established compatibility criteria for location and schedule requirements. The filter subcontractor 416 process may apply Boolean logic to determine subcontractor qualification status based on the results of location matching and schedule overlap evaluations. Subcontractors that satisfy both location and temporal compatibility requirements may advance to inclusion in the temporary matching array.

When subcontractors meet the qualification criteria, the system may execute include subcontractor 418 operations that add qualified subcontractor identifications to the temporary matching array. The include subcontractor 418 process may store subcontractor identification data in the temporary array structure for subsequent processing and ranking operations. The inclusion process may maintain referential integrity by storing appropriate subcontractor identifiers that correspond to registered participants in the system database.

The system may implement more subcontractors to review 420 operations that determine whether additional subcontractors remain for evaluation in the current matching process. The more subcontractors to review 420 process may control the iterative loop that ensures comprehensive evaluation of all registered subcontractors. When additional subcontractors remain for evaluation, the system may return to the search subcontractors 408 operations to continue the systematic review process.

Following completion of the subcontractor evaluation loop, the system may perform determine if more than one subcontractor 422 operations that assess the quantity of qualified subcontractors identified during the matching process. The determine if more than one subcontractor 422 evaluation may determine whether ranking operations are necessary based on the number of qualified candidates. When multiple subcontractors qualify for a project, the system may proceed to sorting operations to establish preference rankings.

The system may execute sort subcontractors 424 operations that arrange qualified subcontractors according to their trust factor values derived from the trust factor determination process described in relation to FIG. 3. The sort subcontractors 424 process may implement quicksort algorithms that efficiently arrange subcontractor identifications in descending order based on trust factor scores. The sorting operations may ensure that subcontractors with higher trust factor values receive priority positioning in the final matching results.

Further, the system may perform list selected subcontractors 426 operations that generate the final array of matching subcontractors arranged according to their qualification rankings. The list selected subcontractors 426 process may create the short list matching 112 that presents qualified subcontractors to general contractors for selection decisions. The final subcontractor list may provide comprehensive matching results that enable informed decision-making based on objective compatibility and performance criteria rather than subjective relationship preferences.

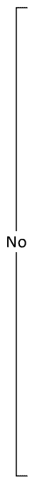

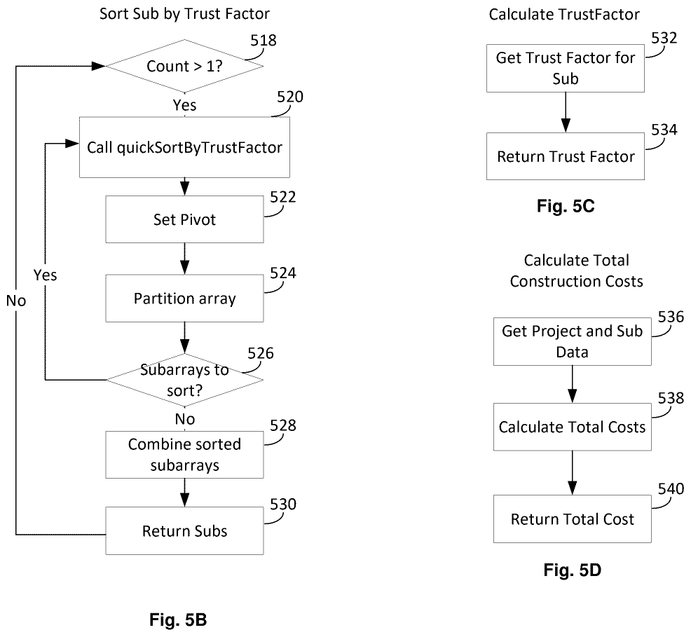

Referring to FIG. 5A, the system may implement a comprehensive subcontractor sorting and cost calculation process that validates project identification and processes matching data through systematic algorithmic operations. The process may begin with a determine valid project identification 502 operation that verifies the project identification corresponds to an existing project within the system database. The determine valid project identification 502 verification may prevent processing of invalid project data and may ensure that subsequent matching operations are performed only for legitimate construction projects stored in the project database 218.

Following successful project validation, the system may execute a select matching subcontractors 504 operation that retrieves qualified subcontractors identified through the find matching subcontractors 402 process described in relation to FIG. 4. The select matching subcontractors 504 operation may sort subcontractors by trust factor values derived from the determine trust factor value 322 calculations, may calculate match count parameters, and may initialize array structures for storing matching data. The select matching subcontractors 504 process may prepare the qualified subcontractor data for systematic evaluation and ranking operations.

The system may implement a search through contractors 506 operation that systematically iterates through all registered general contractors in the system database. The search through contractors 506 process may access the contractor user account 200 data and may evaluate each general contractor for potential matching with the sorted subcontractors. The iterative process may ensure comprehensive evaluation of all contractor-subcontractor combinations to generate complete matching datasets for the procurement process.

With continued reference to FIG. 5A, the system may perform a search sorted subcontractors 508 operation that iterates through the subcontractors arranged according to their trust factor rankings from the select matching subcontractors 504 process. The search sorted subcontractors 508 operation may systematically evaluate each qualified subcontractor in the sorted array to calculate project-specific information and compatibility metrics. The sorted evaluation approach may prioritize subcontractors with higher trust factor values during the matching process.

The system may execute a calculate subcontractor project information 510 operation that retrieves subcontractor addresses from the blockchain storage 220, calculates trust scores using the trust factor determination process, and computes total construction costs for each subcontractor-project combination. The calculate subcontractor project information 510 process may store the calculated match data in array structures that maintain referential integrity between subcontractors, general contractors, and project parameters. The system may maintain subcontractor anonymity during the evaluation process by using indices instead of direct identifiers to eliminate potential bias in the selection process.

Following the calculation of subcontractor project information, the system may perform a determine if more subcontractors 512 operation that evaluates whether additional subcontractors remain for processing in the current iteration. The determine if more subcontractors 512 process may control the iterative loop that ensures comprehensive evaluation of all qualified subcontractors for each general contractor. When additional subcontractors remain for evaluation, the system may return to the search sorted subcontractors 508 operation to continue the systematic processing sequence.

The system may implement a determine if more contractors 514 operation that assesses whether additional general contractors require evaluation in the matching process. The determine if more contractors 514 process may control the outer iterative loop that ensures all registered general contractors are considered for matching with the qualified subcontractors. When additional contractors remain for evaluation, the system may return to the search through contractors 506 operation to continue the comprehensive matching process.

As further shown in FIG. 5A, the system may execute a determine results 516 operation that generates the final match array containing comprehensive matching data for all contractor-subcontractor combinations. The determine results 516 process may compile the calculated trust scores, total construction costs, and matching indices into structured data arrays that facilitate subsequent selection operations. The determine results 516 operation may provide the short list matching 112 data that enables general contractors to make informed selection decisions based on objective performance and cost criteria.

Referring to FIGS. 5B-5D, the system may implement detailed sorting algorithms and calculation processes that support the subcontractor matching operations described in relation to FIG. 5A. As shown in FIG. 5B, the system may perform an if more than one subcontractor 518 evaluation that determines whether sorting operations are necessary based on the quantity of qualified subcontractors. The if more than one subcontractor 518 evaluation may prevent unnecessary sorting operations when only a single subcontractor qualifies for a project, thereby optimizing system performance and computational efficiency.

When multiple subcontractors qualify for sorting, the system may execute a sort by trust factor 520 operation that implements quicksort algorithms to arrange subcontractor identifications according to their trust factor values. The sort by trust factor 520 function may employ a quicksort implementation to efficiently arrange subcontractor IDs based on their trust factors in descending order. The quicksort implementation may provide efficient sorting performance for varying quantities of qualified subcontractors while maintaining consistent algorithmic complexity.

The sorting process may implement a set pivot 522 operation that selects a pivot element from the subcontractor array for partitioning operations. The set pivot 522 process may calculate the pivot position using the formula: left plus the result of right minus left divided by two, where left and right represent the array boundaries for the current sorting operation. The pivot selection may provide balanced partitioning that optimizes sorting performance across different data distributions.

With continued reference to FIGS. 5B-5D, the system may perform a partition selection array 524 operation that rearranges subcontractor elements around the selected pivot based on their trust factor values. The partition selection array 524 process may compare individual subcontractor trust factors with the pivot trust factor value and may relocate elements to appropriate positions relative to the pivot. The partitioning operation may ensure that subcontractors with trust factors greater than the pivot value are positioned before the pivot, while subcontractors with lower trust factors are positioned after the pivot.

The system may execute a determine if there are subarrays to sort 526 operation that evaluates whether additional partitioning and sorting operations are necessary for the current array segments. The determine if there are subarrays to sort 526 process may assess the left and right boundaries of array partitions to determine if recursive sorting operations should continue. When subarrays require additional sorting, the system may return to the sort by trust factor 520 operation to continue the recursive quicksort process.

Following completion of all sorting operations, the system may perform a combine subarrays 528 operation that merges the sorted array segments into a single comprehensive array of subcontractors arranged in descending order by trust factor values. The combine subarrays 528 process may maintain the sorted order established through the recursive quicksort operations and may prepare the final sorted array for subsequent matching operations. The system may then execute a provide subcontractors 530 operation that returns the sorted subcontractor array for use in the calculate subcontractor project information 510 process.

As illustrated in FIG. 5C, the system may implement trust factor retrieval operations that support the sorting and matching processes. The system may perform a retrieve subcontractor trust factor 532 operation that accesses trust factor data stored in the blockchain storage 220 for specific subcontractors. The retrieve subcontractor trust factor 532 process may query the immutable trust factor records established through the set project trust factor 324 operations described in relation to FIG. 3. Following data retrieval, the system may execute a return trust factor 534 operation that provides the trust factor value for use in sorting and evaluation algorithms.

As shown in FIG. 5D, the system may implement cost calculation operations that determine total construction costs for subcontractor-project combinations. The system may perform a retrieve subcontracroa and project data 536 operation that accesses subcontractor specification data 102 and general contractor project requirement data 100 from the blockchain storage 220 and project database 218. The retrieve subcontracroa and project data 536 process may compile material costs per square meter, labor costs per square meter, and total quantity parameters necessary for cost calculations.

The system may execute a calculate costs 538 operation that applies the mathematical formula for determining total construction costs based on the retrieved project and subcontractor data. The calculate costs 538 process may implement the formula: Total Construction Cost equals the sum of Material Cost per square meter plus Labor Cost per square meter, multiplied by Total Quantity. This mathematical calculation may provide accurate cost estimates that enable general contractors to evaluate subcontractor proposals based on comprehensive financial analysis. Following the cost calculation, the system may perform a return costs 540 operation that provides the calculated total construction cost value for storage in the matching data arrays and subsequent evaluation processes.

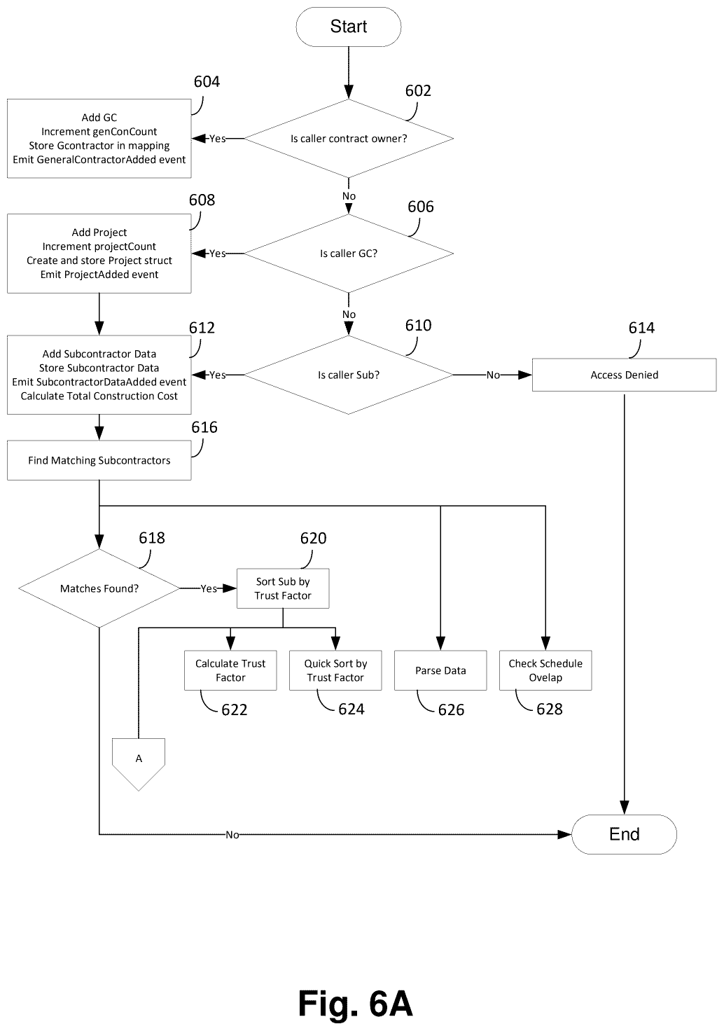

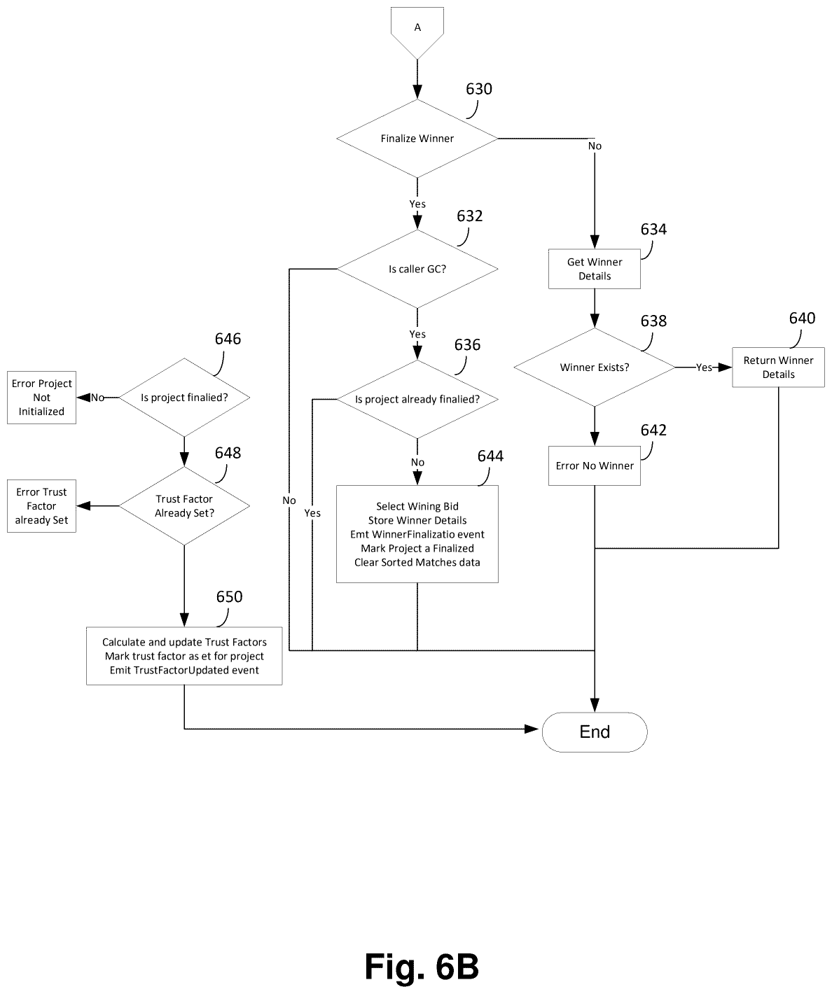

Referring to FIG. 6A, the system may implement a comprehensive access control process that validates user credentials and determines appropriate system actions based on caller identification and authorization levels. The access control process may begin with a caller contract owner 602 verification that determines whether the system caller possesses contract owner privileges within the blockchain-enabled procurement system. The caller contract owner 602 verification may access stored authorization data from the blockchain storage 220 to validate administrative credentials and may prevent unauthorized access to system administration functions.

When the caller possesses contract owner privileges, the system may execute an add contractor 604 operation that enables the registration of new general contractors within the procurement system. The add contractor 604 process may create new contractor records in the project database 218 and may assign unique identification parameters to registered general contractors. The add contractor 604 operation may increment contractor count parameters and may store contractor information including names and Ethereum account addresses in the contractor user account 200 data structures.

When the caller does not possess contract owner privileges, the system may perform a call contractor 606 verification that determines whether the caller corresponds to a registered general contractor within the system. The call contractor 606 verification may access contractor registration data from the contractor user account 200 records to validate contractor credentials and authorization status. The call contractor 606 process may enable registered contractors to access contractor-specific system functions while preventing unauthorized access to administrative operations.

Following successful contractor verification, the system may execute an add project 608 operation that enables registered general contractors to input construction project information into the procurement system. The add project 608 process may access the general contractor project requirement data 100 and may store project details including work schedules, locations, work types, material specifications, labor requirements, and cost estimates in the project database 218. The add project 608 operation may increment project count parameters and may emit ProjectAdded events to notify system participants of new project availability.

With continued reference to FIG. 6A, when the caller fails contractor verification, the system may perform a call subcontractor 610 verification that determines whether the caller corresponds to a registered subcontractor within the system. The call subcontractor 610 verification may access subcontractor registration data from the subcontractor user account 202 records to validate subcontractor credentials and authorization status. The call subcontractor 610 process may enable registered subcontractors to access subcontractor-specific system functions while maintaining appropriate access control boundaries.

Following successful subcontractor verification, the system may execute an add subcontractor 612 operation that enables registered subcontractors to input specification information into the procurement system. The add subcontractor 612 process may access the subcontractor specification data 102 and may store subcontractor details including availability schedules, service locations, work capabilities, material costs, labor costs, and equipment pricing in the blockchain storage 220. The add subcontractor 612 operation may calculate total construction costs for each project using the formula described in relation to the calculate costs 538 operation and may emit SubcontractorDataAdded events to notify system participants of updated subcontractor information.

When the caller fails all credential verifications, the system may implement a system access denied 614 response that prevents unauthorized access to system functions. The system access denied 614 response may terminate the access request and may generate appropriate error notifications to inform unauthorized callers of access restrictions. The system access denied 614 process may maintain system security by preventing unauthorized manipulation of procurement data or system operations.

Following successful data input operations, the system may execute a find matching subcontractors 616 process that implements the automated matching algorithms described in relation to the find matching subcontractors 402 operations in FIG. 4. The find matching subcontractors 616 process may evaluate compatibility between the general contractor project requirement data 100 and the subcontractor specification data 102 using location matching, schedule overlap analysis, and capability assessment algorithms. The find matching subcontractors 616 operation may generate temporary arrays of qualified subcontractors for subsequent evaluation and ranking processes.

The system may perform a determine if match found 618 evaluation that assesses whether qualified subcontractors have been identified through the find matching subcontractors 616 process. The determine if match found 618 evaluation may examine the quantity of subcontractors in the temporary matching arrays and may determine whether subsequent sorting and ranking operations are necessary. When no matches are identified, the system may terminate the matching process and may notify the requesting general contractor of the absence of qualified subcontractors for the specified project parameters.

As further shown in FIG. 6A, when matches are identified, the system may execute a sort subcontrators by trust value 620 operation that implements the sorting algorithms described in relation to the sort by trust factor 520 operations in FIGS. 5B-5D. The sort subcontrators by trust value 620 process may arrange qualified subcontractors in descending order based on their trust factor values derived from the determine trust factor value 322 calculations. The sort subcontrators by trust value 620 operation may ensure that subcontractors with higher performance ratings receive priority positioning in the final matching results.

The sorting process may implement a calculate trust factor 622 operation that retrieves trust factor data from the blockchain storage 220 using the retrieve subcontractor trust factor 532 process described in relation to FIG. 5C. The calculate trust factor 622 operation may access immutable trust factor records established through the set project trust factor 324 operations and may provide trust factor values for comparison during sorting algorithms. The calculate trust factor 622 process may ensure accurate trust factor retrieval for all qualified subcontractors in the matching array.

The system may perform a sort by trust factor 624 operation that implements the quicksort algorithms described in relation to the sort by trust factor 520 process in FIG. 5B. The sort by trust factor 624 operation may utilize the set pivot 522, partition selection array 524, and combine subarrays 528 processes to efficiently arrange subcontractor identifications according to their trust factor rankings. The sort by trust factor 624 process may provide optimized sorting performance while maintaining consistent algorithmic complexity across varying quantities of qualified subcontractors.

The system may execute a parse data 626 operation that extracts and processes temporal information from project requirements and subcontractor availability schedules using the parse project and subcontractor information 410 algorithms described in relation to FIG. 4. The parse data 626 process may convert date information into standardized formats that facilitate accurate temporal compatibility analysis during the matching process. The parse data 626 operation may ensure consistent data formatting for subsequent schedule overlap evaluations.

With continued reference to FIG. 6A, the system may implement a check schedule overlap 628 operation that assesses temporal compatibility between project timelines and subcontractor availability periods using the check schedule 414 algorithms described in relation to FIG. 4. The check schedule overlap 628 process may verify that subcontractor availability periods encompass the required project execution timeframes and may ensure schedule compatibility for all qualified subcontractors in the matching results. The check schedule overlap 628 operation may provide comprehensive temporal validation that supports accurate subcontractor matching.

Referring to FIG. 6B, the system may implement a comprehensive winner finalization process that validates caller credentials, manages project completion status, and processes final subcontractor selection decisions. The winner finalization process may begin with a selection finalized 630 operation that initiates the final selection sequence for completed procurement processes. The selection finalized 630 operation may access the short list matching 112 data generated through the sorting and matching processes described in relation to FIG. 6A and previous figures.

The system may perform an icaller is contractor 632 verification that determines whether the caller requesting winner finalization corresponds to a registered general contractor with authorization to make selection decisions. The icaller is contractor 632 verification may access the contractor user account 200 data to validate contractor credentials and may ensure that only authorized general contractors can finalize subcontractor selections. The icaller is contractor 632 process may prevent unauthorized manipulation of selection outcomes and may maintain the integrity of the procurement process.

When the caller fails contractor verification, the system may execute a selected 634 operation that retrieves existing winner information for completed projects. The selected 634 process may access stored winner data from previous finalization operations and may provide winner details to authorized system participants. The selected 634 operation may enable system participants to query completed procurement outcomes without requiring contractor authorization privileges.

Following the selected 634 operation, the system may perform an award winner exists 638 verification that determines whether winner information has been previously established for the specified project. The award winner exists 638 verification may access winner data stored in the blockchain storage 220 and may confirm the existence of completed selection records. When winner information exists, the system may execute a return award winner 640 operation that provides the stored winner details to the requesting system participant.

With continued reference to FIG. 6B, when winner information does not exist, the system may implement a no winner selected 642 response that notifies the requesting participant of the absence of completed selection data. The no winner selected 642 response may generate appropriate error notifications and may terminate the winner retrieval process when no selection has been finalized for the specified project. The no winner selected 642 process may provide clear feedback regarding the status of procurement processes.

When the caller passes contractor verification through the icaller is contractor 632 process, the system may perform an is project finalized 636 verification that determines whether the specified project has already completed the winner selection process. The is project finalized 636 verification may access project status data from the project database 218 and may prevent duplicate finalization operations for completed projects. When the project has already been finalized, the system may implement a project finalized 646 response that notifies the contractor of the completed status and may prevent additional selection operations.

When the project has not been finalized, the system may execute a select and store winner information 644 operation that processes the final subcontractor selection decision. The select and store winner information 644 process may retrieve matching data from the determine results 516 arrays and may validate that the selected match index falls within valid range parameters. The select and store winner information 644 operation may store comprehensive winner details including general contractor names, subcontractor identifications, material costs per square meter, and labor costs per square meter in the blockchain storage 220.

The select and store winner information 644 process may emit WinnerFinalised events to notify relevant system participants of completed selection outcomes. The WinnerFinalised events may include project identifications, winning general contractor names, selected subcontractor identifications, and cost parameters that provide comprehensive notification of procurement results. The select and store winner information 644 operation may mark the specified project as finalized in the project database 218 and may clear sorted matches data to optimize system performance and storage utilization.

As further shown in FIG. 6B, following winner selection completion, the system may perform a trust factor set 648 verification that determines whether trust factors have been previously established for the completed project. The trust factor set 648 verification may access trust factor status data from the blockchain storage 220 and may prevent duplicate trust factor calculations for projects that have already received performance evaluations. The trust factor set 648 process may ensure that each completed project receives a single comprehensive trust factor assessment.

When trust factors have not been previously established, the system may execute a determine and update trust factor 650 operation that implements the trust factor determination process described in relation to FIG. 3. The determine and update trust factor 650 process may calculate conformity to cost, conformity to time, and conformity to quality ratings using the calculate conformity to cost 316, calculate conformity to time 318, and calculate conformity to quantity 320 operations. The determine and update trust factor 650 operation may combine individual conformity ratings into comprehensive trust factor values using the determine trust factor value 322 algorithms.

The determine and update trust factor 650 process may mark trust factors as set for the completed project to prevent duplicate calculations and may emit TrustFactorUpdated events to notify system participants of updated performance evaluations. The TrustFactorUpdated events may include subcontractor addresses and updated trust factor values that provide notification of performance assessment completion. The determine and update trust factor 650 operation may store the calculated trust factor data in the blockchain storage 220 using the set project trust factor 324 process to ensure immutable storage and traceability of performance evaluations.

The comprehensive access control and winner finalization processes may ensure systematic validation of user credentials, appropriate authorization of system operations, and accurate processing of procurement outcomes. The emission of blockchain events including GeneralContractorAdded, ProjectAdded, SubContractorAdded, SubcontractorDataAdded, TrustFactorUpdated, and WinnerFinalised may provide comprehensive notification capabilities that inform relevant system participants of procurement process outcomes and status changes. These blockchain events may maintain transparency and traceability throughout the procurement process while enabling automated notification of system state changes to all authorized participants.

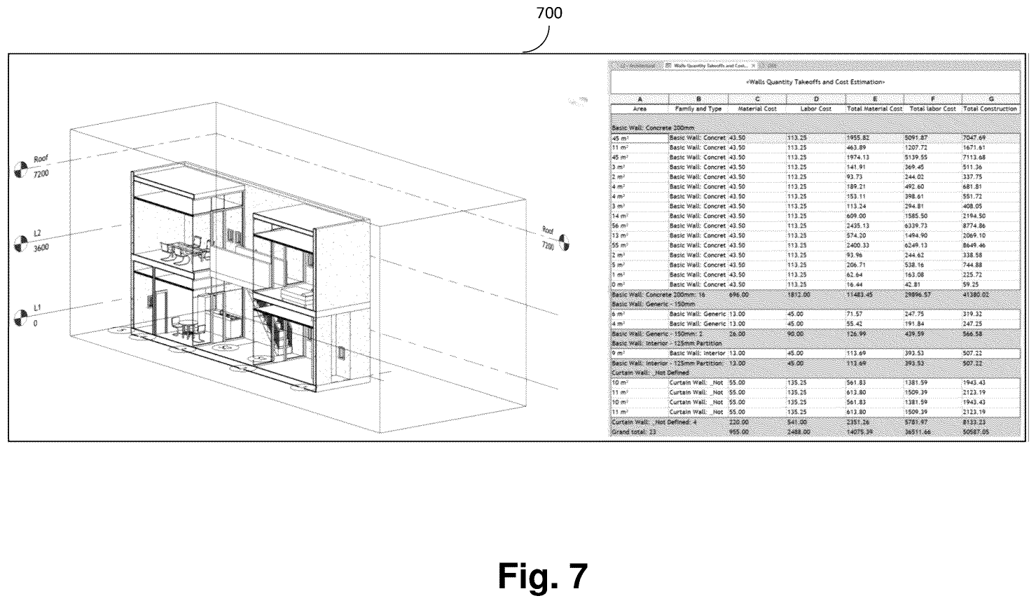

Referring to FIG. 7, the system may utilize a BIM model data 700 that provides comprehensive three-dimensional representation of building structures and associated construction information for procurement processes. The BIM model data 700 may include detailed sectional views of construction projects that display structural elements, material specifications, and dimensional parameters necessary for accurate project estimation and subcontractor matching. The BIM model data 700 may encompass quantity takeoff information that specifies material quantities, labor requirements, and cost estimates derived from the three-dimensional building models.

The BIM model data 700 may contain structured information about building components including concrete walls, structural elements, and architectural features that define the scope of construction work. The three-dimensional sectional view within the BIM model data 700 may display a two-story residential building structure with concrete walls and openings that provide visual representation of the construction project requirements. The quantity takeoff table associated with the BIM model data 700 may present detailed cost information including material costs, labor costs, and total construction estimates organized in tabular format for systematic analysis.

The BIM model data 700 may facilitate the extraction of procurement-relevant information through structured data formats that enable automated processing by the system computer readable instructions 222. The structured nature of the BIM model data 700 may convert unstructured construction information into organized data objects that can be efficiently utilized by various applications and information systems within the procurement process. The BIM model data 700 may provide increased accuracy in measurements, direct linkage of model-extracted quantities to planning software, and comparison capabilities for measurements from different project phases.

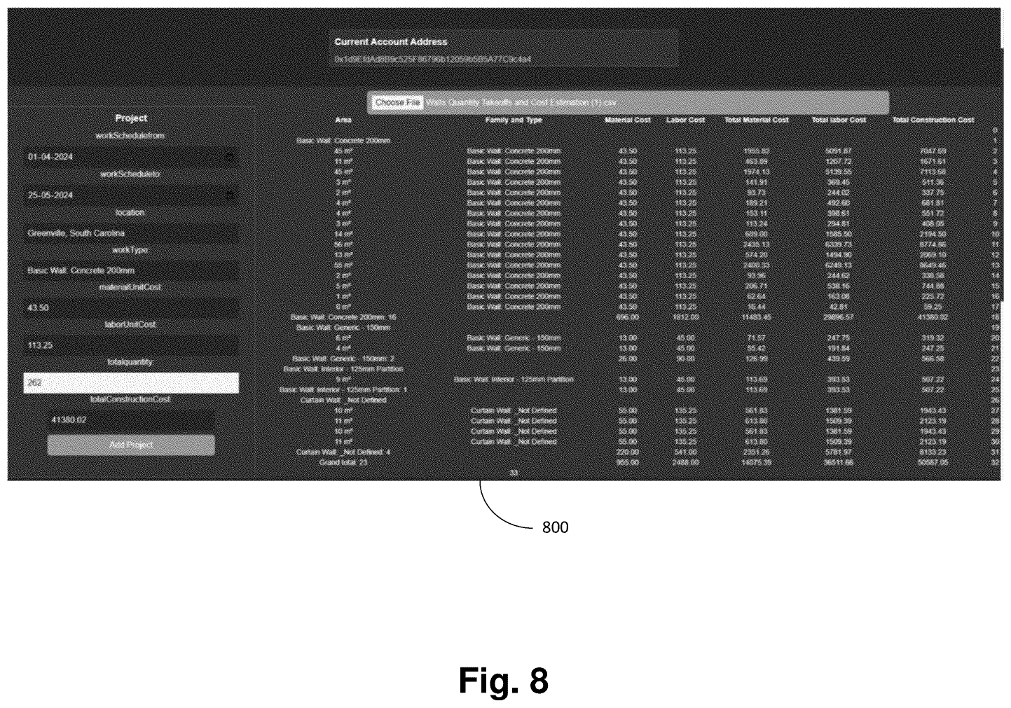

Referring to FIG. 8, the system may implement a contractor interface 800 that displays comprehensive project details in an organized format for general contractor review and data entry operations. The contractor interface 800 may present work schedule information, location data, work types, material costs, and labor costs in structured rows and columns that facilitate efficient viewing and data entry processes. The contractor interface 800 may organize project information in a systematic layout that enables general contractors to review and modify project parameters through the contractor dashboard 208.

The contractor interface 800 may provide input fields for project requirements including work schedule dates, project locations, work type specifications, material unit costs, labor unit costs, total quantity parameters, and total construction cost estimates. The contractor interface 800 may enable general contractors to upload CSV files containing the BIM data 214 extracted from Building Information Modeling software applications. The contractor interface 800 may integrate with the contractor crypto wallet interface 204 to provide secure blockchain-based data submission capabilities for general contractors participating in the procurement system.

The contractor interface 800 may facilitate the input of the general contractor project requirement data 100 through structured form fields that correspond to the data parameters processed by the system computer readable instructions 222. The contractor interface 800 may provide validation capabilities that ensure data completeness and accuracy before submission to the blockchain storage 220. The contractor interface 800 may enable general contractors to review and modify project information prior to initiating the automated matching processes described in relation to the find matching subcontractors 402 operations.

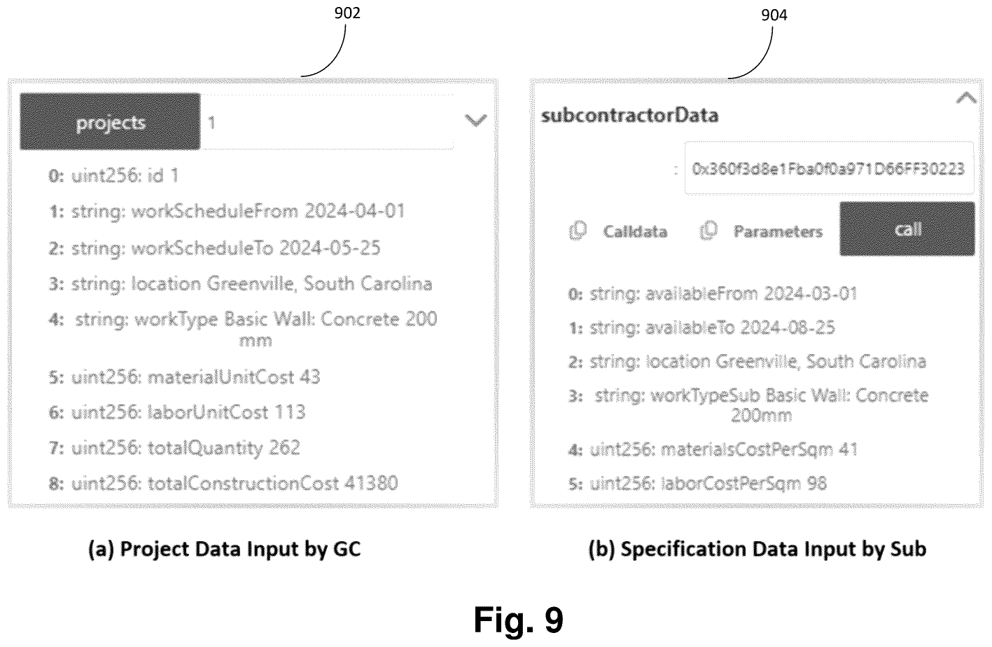

Referring to FIG. 9, the system may implement data input interfaces that enable both general contractors and subcontractors to submit comprehensive information for the automated procurement process. As shown in FIG. 9, a contractor data input 902 interface may display project information fields including work schedule dates, location specifications, work type parameters, material unit cost values, labor unit cost values, total quantity measurements, and total construction cost estimates. The contractor data input 902 interface may correspond to the general contractor project requirement data 100 and may provide structured input capabilities for project definition and specification.

The contractor data input 902 interface may enable general contractors to specify project timelines including start dates and completion dates that define the temporal requirements for construction work. The contractor data input 902 interface may provide location input fields that specify geographic parameters for project execution and subcontractor matching through the determine location match 412 operations. The contractor data input 902 interface may include work type specification fields that define the categories of construction work required for project completion and subcontractor capability matching.

As further shown in FIG. 9, a subcontractor data input 904 interface may display specification information fields including available dates, location parameters, work type capabilities, materials cost per square meter, and labor cost per square meter. The subcontractor data input 904 interface may correspond to the subcontractor specification data 102 and may enable subcontractors to provide comprehensive capability and pricing information for automated matching processes. The subcontractor data input 904 interface may facilitate the input of availability schedules that define temporal periods when subcontractors can perform construction work.

The subcontractor data input 904 interface may provide location specification fields that define geographic service areas for subcontractor operations and compatibility assessment through the determine location match 412 algorithms. The subcontractor data input 904 interface may include work type capability fields that specify the categories of construction work that subcontractors can perform, enabling capability matching with project requirements. The subcontractor data input 904 interface may provide cost input fields for materials cost per square meter and labor cost per square meter that enable accurate cost calculations through the calculate costs 538 operations.

The system may utilize Papa Parse tool functionality to extract data from CSV files created by BIM models and convert BIM-based CSV files to JSON objects for processing by the system computer readable instructions 222. The Papa Parse tool may provide versatility in parsing both local and online files, offering necessary flexibility for data submission through the contractor interface 800 and contractor data input 902 interface. The Papa Parse tool may integrate seamlessly with the blockchain-enabled system through web-based functionality that enhances accessibility for general contractors uploading the BIM data 214.

The Papa Parse tool may implement CSV parsing algorithms that read uploaded files as text, split content into individual lines, remove header information, and extract field data from the first line of the CSV file. The Papa Parse tool may reconstruct CSV content without header information and may parse the content with header options enabled to generate structured data objects. The Papa Parse tool may add unique key identifiers to each parsed item and may store the parsed data and field information for subsequent processing by the system computer readable instructions 222.

The Papa Parse tool may extract work types, material types, estimated material costs, labor costs, and equipment unit costs from the BIM-generated CSV files and may convert this information into JSON objects that can be processed by the blockchain-enabled smart contracts. The Papa Parse tool may support the automated extraction of quantity takeoff data from the BIM model data 700 and may facilitate the integration of structured construction information into the procurement matching algorithms. The Papa Parse tool may provide analytical capabilities that support the processing of performance data and bid information, enabling more informed subcontractor selection through comprehensive data analysis and automated prequalification processes.

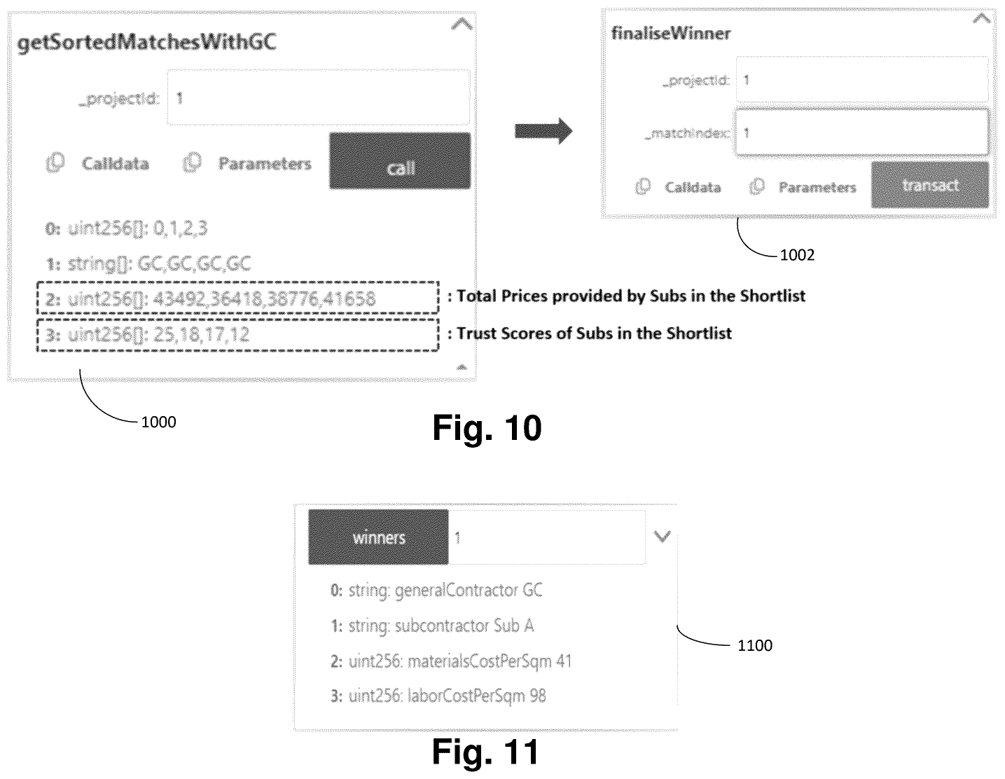

Referring to FIGS. 10-11, the system may implement a comprehensive sequence diagram that illustrates the generation and processing of subcontractor selection data through blockchain-enabled smart contract operations. As shown in FIGS. 10-11, a short list of selected subcontractors 1000 may be generated through the automated matching and sorting processes described in relation to the determine results 516 operations. The short list of selected subcontractors 1000 may contain qualified subcontractors arranged according to their trust factor rankings and cost calculations derived from the sort by trust factor 520 and calculate costs 538 operations.

The short list of selected subcontractors 1000 may provide comprehensive matching data including subcontractor indices, general contractor names, total construction costs, and trust scores that enable informed selection decisions by general contractors. The short list of selected subcontractors 1000 may maintain subcontractor anonymity during the evaluation process by using indices instead of direct identifiers, effectively eliminating potential bias in the selection process while providing objective criteria for decision-making.

With continued reference to FIGS. 10-11, the system may process a finalized subcontractor selected 1002 operation that represents the completion of the subcontractor selection process by general contractors. The finalized subcontractor selected 1002 operation may correspond to the select and store winner information 644 process described in relation to FIG. 6B, where general contractors choose from the short list of selected subcontractors 1000 based on comprehensive performance and compatibility analysis. The finalized subcontractor selected 1002 process may validate that the selected match index falls within valid range parameters and may retrieve detailed data for the winning subcontractor.

Following the finalized subcontractor selected 1002 operation, the system may implement a winner information smart contract 1100 that records comprehensive winner details in the blockchain storage 220. The winner information smart contract 1100 may store winning general contractor names, selected subcontractor identifications, material costs per square meter, and labor costs per square meter using immutable blockchain storage capabilities. The winner information smart contract 1100 may emit WinnerFinalised events that notify relevant system participants of completed selection outcomes and may provide transparency and accessibility to finalized procurement data.

The winner information smart contract 1100 may ensure that procurement outcomes are recorded immutably in the blockchain storage 220, preventing alteration or manipulation of selection results after completion. The winner information smart contract 1100 may maintain referential integrity between general contractors, selected subcontractors, and project parameters while providing comprehensive documentation of procurement decisions. The sequence diagram illustrated in FIGS. 10-11 may demonstrate the systematic flow of information from the initial short list of selected subcontractors 1000 through the finalized subcontractor selected 1002 process to the final recording of winner data in the winner information smart contract 1100.

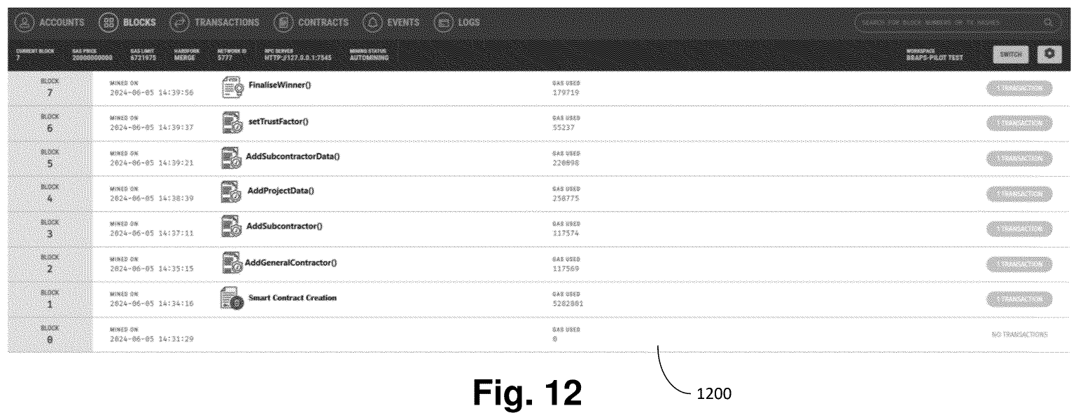

Referring to FIG. 12, the system may implement smart contract blocks 1200 that represent individual transactions in the blockchain-enabled procurement process. The smart contract blocks 1200 may include a sequence of operations that demonstrate the progression of procurement activities from initial system setup through final winner selection and trust factor evaluation. The smart contract blocks 1200 may illustrate the chronological order of blockchain transactions that occur during the automated procurement process, with each block representing a specific operation executed by the system computer readable instructions 222.

The smart contract blocks 1200 may include a Smart Contract Creation transaction that establishes the initial blockchain-based procurement system and deploys the smart contract code to the Ethereum blockchain network. The Smart Contract Creation transaction may consume significant gas resources due to the comprehensive nature of the smart contract deployment and may establish the foundational infrastructure for subsequent procurement operations. The Smart Contract Creation transaction may initialize the system parameters and may prepare the blockchain environment for contractor and subcontractor registration processes.

As further shown in FIG. 12, the smart contract blocks 1200 may include an AddGeneralContractor transaction that corresponds to the add contractor 604 operation described in relation to FIG. 6A. The AddGeneralContractor transaction may register new general contractors within the procurement system and may create contractor records in the project database 218 with unique identification parameters. The AddGeneralContractor transaction may increment contractor count parameters and may store contractor information including names and Ethereum account addresses in the contractor user account 200 data structures.

The smart contract blocks 1200 may include an AddSubcontractor transaction that corresponds to the add subcontractor 612 operation and may enable the registration of subcontractors within the blockchain-enabled procurement system. The AddSubcontractor transaction may create subcontractor records and may assign unique identification parameters to registered subcontractors in the subcontractor user account 202 data structures. The AddSubcontractor transaction may prepare the system for subsequent subcontractor data input through the AddSubcontractorData transaction.

With continued reference to FIG. 12, the smart contract blocks 1200 may include an AddProjectData transaction that corresponds to the add project 608 operation and may enable registered general contractors to input construction project information into the procurement system. The AddProjectData transaction may store the general contractor project requirement data 100 including work schedules, locations, work types, material specifications, labor requirements, and cost estimates in the project database 218. The AddProjectData transaction may increment project count parameters and may emit ProjectAdded events to notify system participants of new project availability.

The smart contract blocks 1200 may include an AddSubcontractorData transaction that corresponds to the add subcontractor 612 operation and may enable registered subcontractors to input specification information into the procurement system. The AddSubcontractorData transaction may store the subcontractor specification data 102 including availability schedules, service locations, work capabilities, material costs, labor costs, and equipment pricing in the blockchain storage 220. The AddSubcontractorData transaction may calculate total construction costs for each project using the calculate costs 538 operations and may emit SubcontractorDataAdded events to notify system participants of updated subcontractor information.

The smart contract blocks 1200 may include a setTrustFactor transaction that corresponds to the determine and update trust factor 650 operation described in relation to FIG. 6B. The setTrustFactor transaction may implement the trust factor determination process including the calculate conformity to cost 316, calculate conformity to time 318, and calculate conformity to quantity 320 operations. The setTrustFactor transaction may combine individual conformity ratings into comprehensive trust factor values using the determine trust factor value 322 algorithms and may store the calculated trust factor data in the blockchain storage 220.

As further shown in FIG. 12, the smart contract blocks 1200 may include a FinalizeWinner transaction that corresponds to the select and store winner information 644 operation and may process final subcontractor selection decisions. The FinalizeWinner transaction may retrieve matching data from the determine results 516 arrays and may validate that selected match indices fall within valid range parameters. The FinalizeWinner transaction may store comprehensive winner details in the winner information smart contract 1100 and may emit WinnerFinalised events to notify relevant system participants of completed selection outcomes.

The smart contract blocks 1200 may demonstrate the systematic progression of blockchain transactions that occur during the automated procurement process, with each transaction consuming Ethereum Gas resources for execution on the blockchain network. The smart contract blocks 1200 may illustrate the gas usage values associated with each transaction type, providing transparency regarding the computational costs of different procurement operations. The sequential arrangement of the smart contract blocks 1200 may show the logical flow of operations from system initialization through final winner selection and performance evaluation.

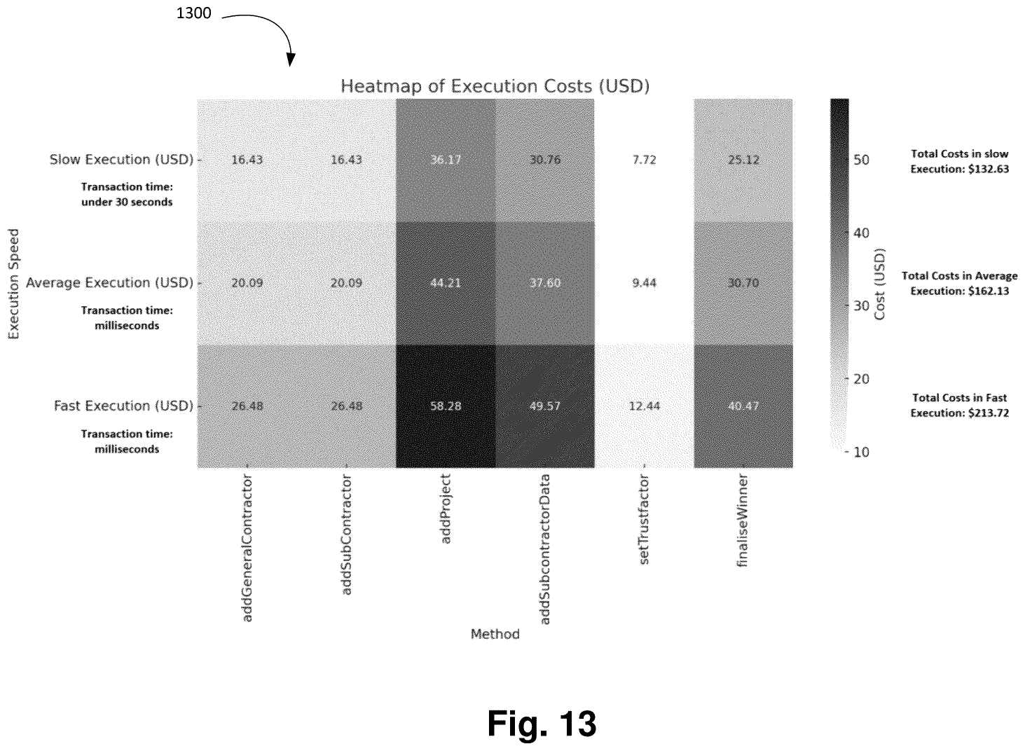

Referring to FIG. 13, the system may implement a heat map 1300 that displays execution costs in United States Dollars for different transaction speeds across the various smart contract operations represented in the smart contract blocks 1200. The heat map 1300 may illustrate cost variations for slow execution, average execution, and fast execution speeds on the vertical axis, with different transaction methods displayed on the horizontal axis. The heat map 1300 may provide comprehensive cost analysis that enables system participants to understand the financial implications of different execution speed selections for blockchain transactions.

The heat map 1300 may display costs ranging from approximately ten dollars to fifty dollars for individual transactions, with total costs for complete procurement processes ranging from approximately one hundred thirty-two dollars and sixty-three cents for slow execution to two hundred thirteen dollars and seventy-two cents for fast execution. The heat map 1300 may utilize a color scale ranging from light to dark blue indicating cost values, with darker colors representing higher execution costs associated with faster transaction processing speeds.

The heat map 1300 may demonstrate that all transactions in the smart contract blocks 1200 may be processed in milliseconds at average and fast execution settings and in minutes at slow execution settings. The processing time efficiency shown in the heat map 1300 may be particularly advantageous when compared to the time required for traditional subcontractor selection processes that rely on manual evaluation and relationship-based decision-making. The heat map 1300 may provide cost-benefit analysis data that demonstrates the economic feasibility of the blockchain-enabled procurement system relative to the financial scale of construction projects.

With continued reference to FIG. 13, the heat map 1300 may include cost calculations based on gas costs provided by Ethereum gas tracking services and may reflect real-time pricing data for blockchain transaction execution. The heat map 1300 may show that the total cost of operating the automated procurement system for a complete subcontracting procurement process falls within reasonable parameters considering the financial scale of construction projects and the potential cost savings achieved through improved subcontractor selection and reduced relationship bias.

The system may be tested using the Remix Integrated Development Environment and Ganache virtual Ethereum blockchain for smart contract development and testing purposes. The Remix Integrated Development Environment may provide web-based functionality that facilitates coding, testing, and deployment of smart contracts to the Ethereum blockchain network. The Remix Integrated Development Environment may offer detailed transaction feedback including sender addresses, call arguments, return values, execution details, and gas costs that enable comprehensive validation of smart contract operations.

The Remix Integrated Development Environment may include exception handling features that provide informative error messages for runtime errors, gas limit exceedances, and smart contract restrictions, supporting rigorous validation of the system computer readable instructions 222. The Remix Integrated Development Environment may enable the writing and testing of Solidity codes that embody the automated procurement algorithms described in relation to the various figures, ensuring robust and reliable smart contract implementation for automated matching without relationship bias in the subcontracting process.

Ganache may provide a virtual Ethereum blockchain environment for testing the blockchain-enabled smart contracts in a simulated environment for debugging before live deployment. Ganache may enable testing of the smart contract operations using virtual Ethereum accounts that simulate the contractor user account 200 and subcontractor user account 202 functionality without requiring actual cryptocurrency transactions. Ganache may provide controlled testing conditions that allow comprehensive validation of the automated matching algorithms, trust factor calculations, and winner selection processes described throughout the system architecture.

The testing methodology using the Remix Integrated Development Environment and Ganache may serve as proof-of-concept validation for the blockchain-enabled procurement system, demonstrating the feasibility and effectiveness of the automated matching processes. The testing approach may streamline the development process and may improve the quality of the final smart contract implementation by ensuring robust, efficient, and reliable automated matching capabilities. The comprehensive testing environment may validate the elimination of relationship bias in subcontracting processes through objective data-driven decision-making and immutable storage of procurement outcomes in the blockchain storage 220.

The system computer readable instructions may implement nine blockchain-enabled smart contract algorithms that provide comprehensive functionality for automated procurement processes. These algorithms may execute on the Ethereum blockchain network using Solidity programming language and may facilitate decentralized matching between general contractors and subcontractors through systematic evaluation of project requirements and subcontractor capabilities.

The Add General Contractor and Project algorithm may enable the registration of general contractors by contract administrators and may facilitate the input of construction project details by registered contractors. The algorithm may increment a general contractor count parameter and may create new contractor data structures with provided names and Ethereum account addresses. The Add General Contractor and Project algorithm may store contractor information in general contractor mapping structures using incremented count values as identification keys and may emit GeneralContractorAdded events with contractor identification numbers and names.

The Add General Contractor and Project algorithm may increment project count parameters and may create new project data structures with comprehensive project details including identification numbers, work schedule start dates, work schedule end dates, project locations, work types, material unit costs, labor unit costs, total quantities, and total construction costs. The algorithm may store project information in project mapping structures using project count values as identification keys and may emit ProjectAdded events with project identification numbers and work types to notify system participants of new project availability.

The CSV Parsing Algorithm may extract construction project data from BIM-generated CSV files through systematic parsing operations that convert structured file data into JSON objects for blockchain processing. The algorithm may initialize FileReader objects and may read uploaded files as text content for subsequent parsing operations. The CSV Parsing Algorithm may split file content into individual lines and may remove header information by splicing the first line from the content array.

The CSV Parsing Algorithm may extract field information from the first line of the CSV content and may reconstruct the file content without header information for parsing operations. The algorithm may utilize Papa Parse functionality to parse CSV content with header options enabled and may generate structured data objects from the parsed content. The CSV Parsing Algorithm may add unique key identifiers to each parsed data item and may store the parsed data and field information for subsequent processing by blockchain smart contracts.

The Add Subcontractor Data and Calculate Total Cost algorithm may facilitate subcontractor registration by contract administrators and may enable subcontractors to input specification data including availability schedules, locations, work types, material costs per square meter, and labor costs per square meter. The algorithm may increment subcontractor count parameters and may create contractor data structures with subcontractor names and Ethereum account addresses. The Add Subcontractor Data and Calculate Total Cost algorithm may store subcontractor information in subcontractor mapping structures and may emit SubContractorAdded events with subcontractor identification numbers and names.

The Add Subcontractor Data and Calculate Total Cost algorithm may store subcontractor specification data in mapping structures linked to subcontractor Ethereum addresses and may emit SubcontractorDataAdded events to notify system participants of updated subcontractor information. The algorithm may automatically calculate total construction costs for each project by iterating through all registered projects and may apply the mathematical formula: Total Construction Cost equals the sum of Material Cost per square meter plus Labor Cost per square meter, multiplied by Total Quantity. The algorithm may link calculated construction costs to specific subcontractor addresses for subsequent matching and evaluation operations.

The Set Trust Factor algorithm may calculate and update trust scores for subcontractors based on performance evaluations from completed construction projects. The algorithm may validate project identification parameters and may verify that projects have reached finalization status before processing trust factor calculations. The Set Trust Factor algorithm may confirm that trust factors have not been previously established for specific projects to prevent duplicate calculations and may ensure that each completed project receives a single comprehensive performance evaluation.

The Set Trust Factor algorithm may retrieve subcontractor identification numbers from winner records and may access subcontractor Ethereum addresses from subcontractor mapping structures. The algorithm may implement averaging calculations that combine new performance ratings with existing historical ratings to introduce gradual adjustments to trust factor values. The Set Trust Factor algorithm may calculate conformity to cost, conformity to time, and conformity to quality ratings by dividing the sum of existing ratings plus new ratings by the total number of rating entries. The algorithm may validate that calculated trust factor totals do not exceed maximum threshold values and may emit TrustFactorUpdated events to notify system participants of completed performance evaluations.

The Parse Date and Check Schedule Overlap algorithm may extract temporal information from date strings and may evaluate schedule compatibility between project requirements and subcontractor availability periods. The algorithm may implement date parsing functions that convert string representations into integer values by extracting year, month, and day components from standardized date formats. The Parse Date and Check Schedule Overlap algorithm may calculate integer date values using the formula: year multiplied by ten thousand plus month multiplied by one hundred plus day.

The Parse Date and Check Schedule Overlap algorithm may implement schedule overlap verification functions that compare project start dates, project end dates, subcontractor start dates, and subcontractor end dates to determine temporal compatibility. The algorithm may convert all date parameters to integer format using the date parsing functions and may evaluate whether subcontractor availability periods encompass required project execution timeframes. The algorithm may return Boolean values indicating schedule compatibility when subcontractor start dates occur before or coincide with project start dates and when subcontractor end dates occur after or coincide with project completion dates.

The Find Matching Subcontractors algorithm may systematically evaluate compatibility between project requirements and subcontractor capabilities through comprehensive algorithmic analysis. The algorithm may validate project identification parameters and may retrieve project details from project mapping structures for compatibility evaluation. The Find Matching Subcontractors algorithm may initialize temporary arrays for storing potential matching subcontractors and may implement iterative loops that examine all registered subcontractors for qualification assessment.

The Find Matching Subcontractors algorithm may retrieve subcontractor Ethereum addresses and specification data for each registered participant and may implement location matching using keccak256 hash functions to compare subcontractor locations with project location requirements. The algorithm may utilize the Parse Date and Check Schedule Overlap algorithm to assess temporal compatibility between project timelines and subcontractor availability periods. The Find Matching Subcontractors algorithm may add qualified subcontractor identification numbers to temporary matching arrays when both location and schedule compatibility criteria are satisfied.

The Find Matching Subcontractors algorithm may implement conditional sorting operations when multiple subcontractors qualify for projects and may utilize the Sort Subcontractors by Trust Factor algorithm to arrange qualified candidates according to performance rankings. The algorithm may create final matching arrays with appropriate capacity for qualified subcontractors and may transfer subcontractor identification numbers from temporary arrays to final matching structures for subsequent processing operations.

The Sort Subcontractors by Trust Factor algorithm may implement quicksort functionality to efficiently arrange subcontractor identification numbers according to trust factor values in descending order. The algorithm may evaluate whether sorting operations are necessary based on the quantity of qualified subcontractors and may implement recursive quicksort operations when multiple candidates require ranking. The Sort Subcontractors by Trust Factor algorithm may implement pivot selection using the formula: left plus the result of right minus left divided by two, where left and right represent array boundaries for current sorting operations.

The Sort Subcontractors by Trust Factor algorithm may implement partitioning operations that rearrange subcontractor elements around selected pivot values based on trust factor comparisons. The algorithm may utilize while loops to position subcontractors with trust factors greater than pivot values before the pivot position and may position subcontractors with lower trust factors after the pivot position. The Sort Subcontractors by Trust Factor algorithm may implement recursive calls to continue sorting operations for array segments that require additional partitioning until all subcontractors are arranged in descending order by trust factor values.

The Get Sorted Matches with General Contractor algorithm may create comprehensive pairings between sorted subcontractors and general contractors through systematic evaluation and data compilation operations. The algorithm may validate project identification parameters and may retrieve matching subcontractors using the Find Matching Subcontractors algorithm for subsequent processing. The Get Sorted Matches with General Contractor algorithm may sort matching subcontractors using the Sort Subcontractors by Trust Factor algorithm and may calculate match count parameters based on the product of sorted subcontractor quantities and general contractor quantities.

The Get Sorted Matches with General Contractor algorithm may initialize arrays for storing match indices, general contractor names, total construction costs, and trust scores with capacity equal to calculated match count parameters. The algorithm may implement nested iterative loops that examine each general contractor in combination with each sorted subcontractor to generate comprehensive matching datasets. The Get Sorted Matches with General Contractor algorithm may retrieve subcontractor Ethereum addresses, calculate trust scores using trust factor calculation functions, and compute total construction costs using cost calculation algorithms for each contractor-subcontractor pairing.

The Get Sorted Matches with General Contractor algorithm may maintain subcontractor anonymity by storing match indices instead of direct subcontractor identifiers in the matching arrays, effectively eliminating potential bias in selection processes while providing objective evaluation criteria. The algorithm may store general contractor names, calculated total construction costs, and trust scores in corresponding array positions and may increment array index parameters for each processed contractor-subcontractor combination. The Get Sorted Matches with General Contractor algorithm may return comprehensive arrays containing match indices, general contractor names, total construction costs, and trust scores that provide complete datasets for final selection processes.

The Finalise Winner and Get Winner algorithm may process final subcontractor selection decisions and may retrieve winner information for completed procurement processes. The algorithm may implement caller verification functions that confirm requesting parties correspond to registered general contractors with authorization to finalize selections or to system participants with authorization to query winner information. The Finalise Winner and Get Winner algorithm may validate that specified projects have not been previously finalized to prevent duplicate selection operations and may ensure that each project receives a single winner selection.

The Finalise Winner and Get Winner algorithm may retrieve matching data from the Get Sorted Matches with General Contractor arrays and may validate that selected match indices fall within valid range parameters for the matching dataset. The algorithm may extract winning general contractor names and winning subcontractor addresses from the matching arrays based on provided match index parameters. The Finalise Winner and Get Winner algorithm may retrieve comprehensive subcontractor specification data using winning subcontractor addresses and may store winner details in winner mapping structures with project identification numbers as keys.

The Finalise Winner and Get Winner algorithm may store winning general contractor names, selected subcontractor identification numbers, material costs per square meter, and labor costs per square meter in winner data structures for permanent record keeping. The algorithm may emit WinnerFinalised events that include project identification numbers, winning general contractor names, selected subcontractor identification numbers, material costs per square meter, and labor costs per square meter to notify system participants of completed selection outcomes. The Finalise Winner and Get Winner algorithm may mark specified projects as finalized in project status mapping structures and may clear sorted matches arrays to optimize system performance and storage utilization.

The Finalise Winner and Get Winner algorithm may implement winner retrieval functions that validate project identification parameters and may confirm the existence of winner records for specified projects. The algorithm may retrieve comprehensive winner details from winner mapping structures and may return winning general contractor names, selected subcontractor identification numbers, material costs per square meter, and labor costs per square meter to requesting system participants. The Finalise Winner and Get Winner algorithm may provide error responses when winner information does not exist for specified projects, ensuring clear communication of procurement process status to system participants.

The system may operate through a comprehensive sequence of interconnected processes that facilitate automated procurement while maintaining decentralization and eliminating relationship bias through blockchain-enabled smart contract execution. The complete procurement process may begin when general contractors access the system through their user accounts and authenticate using crypto wallet interfaces that provide secure blockchain connectivity. General contractors may utilize their dashboards to initiate project data input processes that capture comprehensive construction project requirements including work schedules, geographic locations, work type specifications, material requirements, and cost parameters.

The project data input process may enable general contractors to upload CSV files containing structured construction information extracted from Building Information Modeling software applications. The system may implement Papa Parse functionality to process these uploaded files through systematic parsing operations that convert BIM-generated data into structured JSON objects suitable for blockchain processing. The Papa Parse tool may extract work types, material specifications, quantity measurements, cost estimates, and scheduling information from the uploaded files while maintaining data integrity and accuracy throughout the conversion process.

Following successful data extraction and parsing, the system may transmit the processed project information to blockchain storage through secure cryptographic transactions that ensure data immutability and traceability. The blockchain storage process may encrypt project data and distribute the information across the decentralized network while maintaining selective access controls that prevent unauthorized disclosure of sensitive project information. The stored project data may become available for automated matching processes while preserving confidentiality until appropriate subcontractor matches are identified.

Concurrently with general contractor data input processes, subcontractors may access the system through their user accounts and authenticate using crypto wallet interfaces that provide secure blockchain connectivity for specification data submission. Subcontractors may utilize their dashboards to input comprehensive capability information including availability schedules, service geographic areas, work type capabilities, material cost parameters, labor cost parameters, and equipment pricing information. The subcontractor data input process may capture detailed specification information that enables accurate compatibility assessment during automated matching operations.

The system may process subcontractor specification data through validation algorithms that ensure data completeness and accuracy before transmission to blockchain storage. The subcontractor data may be encrypted and stored in the decentralized blockchain network with access controls that prevent unauthorized disclosure of sensitive pricing and capability information. The stored subcontractor data may become available for automated matching processes while maintaining confidentiality until appropriate project matches are identified through compatibility analysis.

The automated matching process may initiate when both general contractor project requirements and subcontractor specification data are available in the blockchain storage system. The matching algorithms may systematically evaluate compatibility between project requirements and subcontractor capabilities through comprehensive analysis of multiple parameters including geographic location compatibility, temporal schedule alignment, work type capability matching, and cost parameter evaluation. The location matching process may utilize cryptographic hash functions to compare project locations with subcontractor service areas while maintaining data security and accuracy throughout the comparison operations.

The schedule overlap analysis may extract temporal information from both project timelines and subcontractor availability periods to determine compatibility between required project execution timeframes and subcontractor availability windows. The schedule compatibility evaluation may convert date information into standardized formats that facilitate accurate temporal analysis and may verify that subcontractor availability periods encompass the complete project execution timeline from start to completion dates.

The work type capability matching process may compare project work requirements with subcontractor capability specifications to ensure that qualified subcontractors possess the technical expertise and resources necessary for successful project completion. The capability matching algorithms may evaluate multiple work type categories and may verify that subcontractors can perform the specific construction activities required for each project.

Following compatibility assessment across location, schedule, and capability parameters, the system may calculate trust factor scores for qualified subcontractors based on historical performance data stored in the blockchain system. The trust factor calculation process may retrieve performance evaluation data from previous projects and may assess subcontractor reliability across cost conformity, time adherence, and quality delivery metrics. The trust factor calculations may implement averaging algorithms that combine historical performance data with recent project outcomes to generate comprehensive reliability scores that reflect subcontractor performance patterns over time.

The system may process qualified subcontractors through sorting algorithms that arrange candidates according to their trust factor rankings in descending order. The sorting process may implement efficient quicksort algorithms that organize subcontractor data while maintaining referential integrity and ensuring accurate ranking based on performance metrics. The sorted subcontractor data may be combined with cost calculation results that determine total construction costs for each subcontractor based on their material costs, labor costs, and project quantity requirements.

The cost calculation process may apply mathematical formulas that multiply subcontractor unit costs by project quantities to generate comprehensive cost estimates for each qualified subcontractor. The cost calculations may provide accurate financial analysis that enables general contractors to evaluate subcontractor proposals based on both performance metrics and economic considerations during the selection process.

The system may generate anonymized shortlists that present qualified subcontractors to general contractors without revealing subcontractor identities during the evaluation process. The anonymization process may utilize index-based identification systems that eliminate relationship bias by preventing general contractors from making selection decisions based on prior relationships or subjective preferences. The shortlists may include trust factor scores, total construction costs, and compatibility metrics while maintaining subcontractor anonymity throughout the evaluation period.

General contractors may review the anonymized shortlists through their dashboards and may evaluate qualified subcontractors based solely on objective performance metrics and cost parameters. The review process may enable general contractors to compare multiple qualified candidates using comprehensive data analysis rather than relationship preferences or subjective criteria. The objective evaluation approach may ensure fair competition among subcontractors and may enable selection decisions based on merit and capability rather than prior business relationships.

The winner selection process may enable general contractors to choose preferred subcontractors from the anonymized shortlists based on their evaluation of trust factor scores, construction costs, and project compatibility metrics. The selection process may validate that chosen subcontractors correspond to valid entries in the shortlist data and may ensure that selection decisions are recorded accurately in the blockchain system. The winner selection may trigger automated smart contract execution that processes the final selection decision and initiates contract finalization procedures.

The contract finalization process may retrieve comprehensive information about selected subcontractors and may record winner details in immutable blockchain storage through smart contract operations. The finalization process may store winning general contractor information, selected subcontractor details, material cost parameters, labor cost parameters, and project identification data in permanent blockchain records that cannot be altered or manipulated after completion.

The system may emit blockchain events that notify relevant system participants of completed selection outcomes and contract finalization results. The blockchain events may include comprehensive information about winning selections and may provide transparent notification of procurement process completion to all authorized system participants. The event emission process may maintain system transparency while ensuring that all stakeholders receive appropriate notification of procurement outcomes.

The trust factor update process may calculate and record performance evaluations for completed projects to maintain accurate historical performance data for future procurement processes. The trust factor updates may assess subcontractor performance across cost conformity, time adherence, and quality delivery metrics based on project outcomes and general contractor evaluations. The updated trust factor data may be stored immutably in the blockchain system and may contribute to future subcontractor evaluations and matching processes.

Throughout the complete procurement process, the system may maintain decentralization by distributing data storage and processing operations across the blockchain network without relying on centralized authorities or intermediaries. The decentralized architecture may ensure that no single entity controls procurement data or decision-making processes, thereby promoting fairness and transparency in subcontractor selection operations.

The blockchain-enabled smart contract execution may automate procurement processes without manual intervention while maintaining transparency through immutable transaction records and comprehensive audit trails. The smart contract automation may reduce human bias in selection processes and may ensure consistent application of objective evaluation criteria across all procurement operations.

The relationship bias elimination may be achieved through anonymization of subcontractor information during evaluation processes and through objective evaluation criteria that prevent selection decisions based on prior business relationships. The anonymization process may ensure that general contractors evaluate subcontractors based solely on performance metrics, cost parameters, and project compatibility rather than subjective relationship preferences.

The system may expand subcontractor participation opportunities by providing equal access to procurement processes regardless of existing relationships with general contractors. The expanded participation may increase competition among subcontractors and may improve overall project outcomes through enhanced subcontractor selection based on merit and capability rather than relationship preferences.

The comprehensive system operation may demonstrate the integration of Building Information Modeling technology, blockchain storage capabilities, smart contract automation, and objective evaluation algorithms to create a transformative procurement platform that addresses traditional limitations in construction subcontractor selection processes while promoting fairness, transparency, and efficiency in procurement operations.

According to one embodiment, the processes, techniques and functionality described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the processes, techniques and functionality, or may include one or more general purpose hardware processors configured, adapted and programmed to perform the processes, techniques and functionality pursuant to program instructions, such as computer readable instructions, in firmware, memory, other storage, or a combination. Such special-purpose computing devices may also combine custom hard-wired logic, ASICs, or FPGAs with custom programming to accomplish the processes, techniques and functionality. The special-purpose computing devices may be desktop computer systems, portable computer systems, handheld devices, networking devices or any other device that incorporates hard-wired and/or program logic to implement the processes, techniques and functionality.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

The blockchain events, algorithms, modules, functionality, processes and procedures described herein may be implemented through computer readable instructions that provide practical applications by transforming procurement concepts into concrete digital representations and automated operations. The system may utilize computer readable instructions stored in memory and executed by processors to create digital representations of physical construction projects, subcontractor capabilities, and performance metrics that enable automated decision-making processes. The system includes digital transformations of physical procurement actions such as contractor registration, project initiation, subcontractor qualification, and winner selection processes. The computer readable instructions may encode these physical procurement activities into cryptographically secured blockchain transactions that provide verifiable digital representations of real-world construction industry operations.

The system may implement smart contract modules through computer readable instructions wthat execute automatically when predetermined conditions are met. These smart contract modules may digitally represent physical contract terms, performance requirements, and payment conditions through executable code that eliminates manual intervention in procurement processes. The computer readable instructions may transform traditional paper-based contract negotiations into automated digital processes that reduce administrative overhead and improve operational efficiency.

The trust factor calculation modules may be implemented through computer readable instructions that process digital representations of physical construction performance data including cost conformity, time adherence, and quality delivery metrics. The computer readable instructions may implement mathematical algorithms that convert subjective performance assessments into objective numerical ratings stored immutably on the blockchain. These digital trust factor representations may enable automated subcontractor ranking processes that improve upon traditional relationship-based selection methods by providing quantifiable performance metrics.

The BIM data integration functionality may be implemented through computer readable instructions that extract and process three-dimensional model components, material specifications, quantity takeoffs, and cost estimates from Building Information Modeling software. The computer readable instructions may transform complex BIM data structures into standardized digital formats suitable for automated procurement evaluation processes. This digital representation of physical construction projects may enable precise matching between project requirements and subcontractor capabilities through algorithmic analysis rather than manual evaluation.

The automated matching algorithms may be implemented through computer readable instructions that systematically evaluate compatibility between digital representations of project requirements and subcontractor specifications. The computer readable instructions may implement location matching functionality using cryptographic hash functions, schedule overlap analysis using temporal comparison algorithms, and capability assessment using structured data evaluation processes. These algorithms may improve computer system operation by reducing computational complexity through efficient sorting and filtering operations.

The blockchain storage modules may be implemented through computer readable instructions that manage distributed ledger operations including data encryption, transaction validation, and consensus mechanisms. The computer readable instructions may implement cryptographic security protocols that ensure data integrity and prevent unauthorized modification of procurement records. This distributed storage approach may improve system reliability and data availability compared to centralized database systems while providing enhanced security through cryptographic protection.

The user interface modules may be implemented through computer readable instructions that generate contractor dashboard 208 and subcontractor dashboard 210 interfaces for data input and system interaction. The computer readable instructions may implement responsive web interfaces that adapt to different device types and screen sizes while maintaining consistent functionality across platforms. These interfaces may provide digital representations of traditional procurement forms and documents through structured data entry fields and automated validation processes.

The access control functionality may be implemented through computer readable instructions that validate user credentials using blockchain-based authentication mechanisms. The computer readable instructions may implement role-based access control that restricts system operations based on user types including contract owners, general contractors, and subcontractors. This access control system may improve security by preventing unauthorized access to sensitive procurement data while enabling appropriate system functionality for authenticated users.

The cost calculation modules may be implemented through computer readable instructions that process material costs, labor costs, and quantity parameters to generate total construction cost estimates. The computer readable instructions may implement mathematical formulas that combine per-unit costs with project quantities to produce accurate financial projections. These automated cost calculations may improve accuracy and reduce processing time compared to manual estimation methods while providing consistent calculation methodologies across all projects.

The system may implement notification modules through computer readable instructions that generate automated alerts and status updates for system participants. The computer readable instructions may implement event-driven notification systems that respond to blockchain events and system state changes by sending appropriate communications to relevant stakeholders. These automated notification processes may improve project coordination and reduce communication delays compared to manual notification methods.

The data validation modules may be implemented through computer readable instructions that verify data integrity, format compliance, and business rule adherence throughout the procurement process. The computer readable instructions may implement validation algorithms that check data consistency, prevent invalid data entry, and ensure compliance with system requirements. These validation processes may improve data quality and reduce errors compared to manual data entry and verification methods.

The sorting and ranking algorithms may be implemented through computer readable instructions that utilize quicksort implementations and comparison functions to arrange subcontractors according to trust factor values and other evaluation criteria.

The computer readable instructions may implement efficient sorting algorithms that provide consistent performance across varying data sizes while maintaining algorithmic complexity within acceptable parameters. These sorting processes may improve system responsiveness and enable real-time ranking of large subcontractor datasets.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computerized automated procurement system comprising:
a server in communications with a immutable ledger;
a first computer system in communications with the server adapted for receiving a set of project requirements originating from a contractor, wherein the set of project requirements includes project information comprising work schedules, project locations, work types, material specifications, labor requirements, and cost estimates;
a second computer system in communications with the server for receiving subcontractor data representing a set of subcontractors;
wherein the server is adapted to match the contractor with a subset of subcontractors taken from the set of subcontractors according to the set of project requirements and subcontractor data; and
creating a proposed smart contract for each contractor and subcontractor match.

2. The system of claim 1, wherein the server includes artificial intelligence algorithms configured to analyze the subcontractor data and project requirements to optimize the matching process and enhance selection accuracy.

3. The system of claim 1, wherein the subcontractor data includes data selected from the group consisting of available dates, available locations, work type capabilities, material type specifications, material pricing, labor pricing, equipment pricing, and performance history.

4. The system of claim 1, wherein the server is configured to create a trust score associated with each subcontractor in the set of subcontractors based on historical performance metrics.

5. The system of claim 4, wherein the trust score is calculated according to criteria selected from the group consisting of cost conformity, time conformity, quality conformity, and any combination thereof.

6. The system of claim 4, wherein the server is adapted to present the subset of subcontractors in trust score order from highest to lowest trust score.

7. The system of claim 1, wherein the first computer system is adapted to receive Building Information Modeling (BIM) data and extract the set of project requirements from the BIM data using computer readable instructions configured to parse CSV files generated by BIM software.

8. A computer system adapted for blockchain-enabled procurement comprising:
a blockchain storage system configured to store contractor project requirements and subcontractor specification data;
a matching module configured to evaluate compatibility between project requirements and subcontractor capabilities using location matching, schedule overlap analysis, and work type capability assessment;
a trust factor calculation module configured to calculate trust scores for subcontractors based on historical performance data including cost conformity, time adherence, and quality delivery metrics; and
a smart contract execution module configured to automate procurement processes and generate anonymized shortlists of qualified subcontractors ranked according to trust factor values.

9. The computer system of claim 8, wherein the blockchain storage system stores contractor data, subcontractor data, project data, and smart contract data on an immutable ledger to ensure permanent and tamper-proof storage of procurement information.

10. The computer system of claim 8, wherein the matching module implements keccak256 hash functions for location matching and temporal comparison algorithms for schedule overlap analysis that verify subcontractor availability periods encompass required project execution timeframes.

11. The computer system of claim 8, including an artificial intelligence assisted subcontractor selection process that learns from past selection outcomes to improve future matching accuracy, wherein the artificial intelligence algorithms analyze historical selection patterns, project success rates, and performance correlations to refine matching criteria and enhance automated decision-making capabilities over time.

12. The computer system of claim 8, wherein the trust factor calculation module implements averaging algorithms that combine new performance ratings with existing historical ratings to introduce gradual adjustments to trust factor values while preventing dramatic fluctuations based on single project outcomes.

13. The computer system of claim 8, wherein the smart contract execution module maintains subcontractor anonymity during evaluation processes by using index-based identification systems instead of direct subcontractor identifiers to eliminate relationship bias in selection decisions.

14. A computerized system for eliminating relationship bias in construction procurement comprising:
a distributed blockchain network configured to store encrypted procurement data with selective access controls;
a Building Information Modeling data integration module configured to extract and process construction project data from BIM software applications;
a crypto wallet interface module configured to provide secure blockchain connectivity for contractors and subcontractors;
an automated matching algorithm configured to systematically evaluate subcontractor compatibility using cryptographic hash functions for location matching and temporal comparison algorithms for schedule overlap analysis;
wherein the system maintains subcontractor anonymity during evaluation processes by using index-based identification systems that prevent selection decisions based on prior relationships;
wherein the system provides subcontractors in ranking order to the contractor based on trust factor values and compatibility metrics; and
wherein when the contractor selects a subcontractor from the ranked list, the relationship is memorialized by smart contract execution that records the selection decision immutably on the blockchain network.

15. The computerized system of claim 14, wherein the distributed blockchain network utilizes Ethereum blockchain technology with smart contracts to ensure immutable storage and cryptographic security of procurement data.

16. The computerized system of claim 14, wherein the Building Information Modeling data integration module implements Papa Parse functionality to extract work types, material specifications, quantity measurements, and cost estimates from generated by BIM software applications.

17. The computerized system of claim 16, wherein the system functionality converts BIM-generated CSV files to JSON objects through systematic parsing operations that remove header information and add unique key identifiers to each parsed data item.

18. The computerized system of claim 14, wherein the crypto wallet interface module utilizes MetaMask accounts to provide private keys and enable connection to decentralized applications through web browsers or mobile app built-in browsers.

19. The computerized system of claim 14, wherein the automated matching algorithm implements quicksort functionality to arrange qualified subcontractors in descending order based on trust factor values derived from historical performance evaluations including cost conformity, time adherence, and quality delivery metrics.

20. The computerized system of claim 19, wherein the quicksort functionality utilizes pivot selection using a formula that calculates left plus the result of right minus left divided by two, where left and right represent array boundaries for current sorting operations.
